(19) United States
(12) Patent Application Publication
(10) Pub. No.: US 2025/0243302 A1
(43) Pub. Date: Jul. 31, 2025

(54) FREE RADICAL ETHYLENE/TERPENE COPOLYMERS

(71) Applicant: Braskem S.A., Camaçari (BR)

(72) Inventors: Adriane Gomes Simanke, São Paulo (BR); Hadi Mohammadi, Philadelphia, PA (US); Manoela Ellwanger Cangussu, São Paulo (BR); Sascha Hintenlang, Philadelphia, PA (US); Markus Busch, Philadelphia, PA (US); Jayme Kennedy, Philadelphia, PA (US)

(73) Assignee: Braskem S.A., Camaçari (BR)

(21) Appl. No.: 18/982,797

(22) Filed: Dec. 16, 2024

Related U.S. Application Data
(60) Provisional application No. 63/610,547, filed on Dec. 15, 2023.

(51) Int. Cl. C08F 210/02; C08F 236/08; C08F 236/22; C08L 23/0807

(52) U.S. Cl. CPC C08F 210/02; C08F 236/08; C08F 236/22; C08L 23/083; C08L 2203/16; C08L 2207/064

(57) ABSTRACT

An ethylene-based polymer comprising from 0.01 to 25 wt. % of at least one terpene comonomer and a method for producing an ethylene-based polymer under a high-pressure system. The present invention further relates to extrusion coating film applications.

### BACKGROUND

Low density polyethylene (LDPE) is a commodity polymer that is produced in tubular or autoclave reactors under high pressure and temperatures. During the polymerization reaction, branches of different lengths and topologies are formed, and the final polymer architecture will be influenced by the polymerization conditions. The polymer microstructure is key to determine the end-use properties of the material, such as mechanical, and rheological properties.

Autoclave reactor is a vessel containing multiple blades to promote adequate mixing, behaving like a continuous stirred tank reactor (CSTR). In general, autoclave reactors operate at pressures varying from 1100 to 2000 bar and temperatures from 150 to 280° C. In turn, tubular reactor comprises of a series of jacketed tubes that operates in a continuous flow mode (plug flow reactors—PFR). Tubular reactors operate at pressures varying from 2000 to 3500 bar and temperatures from 150 to 350° C. In general, the residence time in the reactors is within 10 to 100 s, with about 15-25% conversion for autoclave and 20-40% for tubular reactor.

Both reactor types have specific operating characteristics and product range capabilities, and the polymers produced in these reactors show different microstructure. Autoclave LDPEs show much higher degree of long chain branching (LCB) and branches on branches than tubular LDPEs. Besides, Autoclave LDPEs also show broader molecular weight distribution than the tubular ones. Due to these features, autoclave LDPEs can be used in some applications where tubular LDPEs are not suitable.

It was surprisingly found that adding amounts of terpenes during ethylene polymerization can control the amount of unsaturation and degree of LCB, as well as SCB (short chain branching) distribution in low density polyethylene (LDPE). The presence of multiple double bonds can lead to a branch-on-branch topology in the resulting copolymer. In case of tubular LDPEs, it was also unexpectedly found that it is possible to have tubular LDPE with enhanced melt strength and microstructure, mimicking LDPEs produced in autoclave reactors.

Terpenes, such as farnesene, myrcene and ocimene, are bio-based compounds that offer a large variety of chemical structures. The monomers differ in the size of the backbone and in the amount of unsaturation. During the polymerization reaction, one unsaturation is consumed in the copolymerization with ethylene (or other vinyl monomers). The others can be used as a free site to create branches on branches during the polymerization reaction or to be modified (functionalization, crosslinking, etc.) in post-polymerization reactions.

Free radical high-pressure ethylene/terpene copolymers disclosed in the present invention have the potential to be applied in a large variety of applications for extrusion coatings films, like packaging, adhesives, footwear, etc.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Some aspects of the present invention are related to an ethylene-based polymer comprising from 0.01 to 25 wt. % of at least one terpene comonomer comprising 1 to 5 isoprene units, based on the total weight of the ethylene-based polymer.

Further aspects of the present invention comprise a method to produce an ethylene-based polymer under a high-pressure system.

Other aspects of the present invention also include an extrusion coating film comprising the ethylene-based polymer and an article comprising the extrusion coating film.

### BRIEF DESCRIPTION OF DRAWINGS

FIG. 1 shows Farnesene 1H NMR spectrum.

FIGS. 2A and 2B shows 1H NMR spectra of the ethylene/farnesene copolymers.

FIGS. 3A and 3B shows the unsaturation content of the ethylene/farnesene copolymers.

FIG. 4 shows the molecular weight distribution curves of ethylene/farnesene copolymers measured by 3D-GPC using a viscometer detector.

FIG. 5 shows the crystallization thermogram of the ethylene/farnesene copolymers.

FIG. 6 shows the DSC melting thermogram of the ethylene/farnesene copolymers.

FIGS. 7A-7C show the 1H NMR spectrum for myrcene molecular structure.

FIGS. 8A and 8B show the 1H NMR spectrum for myrcene molecular structure.

FIGS. 9A and 9B show the crystallization and melting thermograms of the ethylene/myrcene copolymers.

FIGS. 10A-10D show the 1H NMR spectra of four different ethylene/isoprene copolymers.

FIGS. 11A and B show the crystallization and melting thermograms of the ethylene/isoprene copolymers.

FIG. 12 shows the farnesene molecular structure in a simulated 1H NMR spectrum.

FIGS. 13A-E shows the 1H NMR spectra of two LDPEs and 3 ethylene/farnesene copolymers.

FIG. 14 shows 1H NMR peak assignments and different possibilities of farnesene addition in the polymer backbone.

FIGS. 15A-15B show the farnesene content in mol % and weight % in the ethylene/farnesene copolymers, respectively.

FIG. 16 shows the 13C NMR spectra of ethylene/farnesene copolymers.

FIG. 17 shows the branching content and distribution according to the farnesene content.

FIG. 18 shows the molecular weight and molecular weight distribution of ethylene/farnesene copolymers measured by 3D-GPC using a viscometer detector.

FIG. 19 shows DSC crystallization curves of ethylene/farnesene copolymers (at lower temperatures).

FIG. 20 shows lower temperature crystallization peak of ethylene/farnesene copolymers.

FIG. 21 shows DSC melting curves of ethylene/farnesene copolymers.

FIG. 22 shows the influence of farnesene amount in the LCB of the polymer.

FIG. 23 shows the 1H NMR spectra of ethylene/farnesene copolymers.

FIG. 24 shows the 1H NMR peak assignments and different possibilities of farnesene insertion in the polymer backbone.

FIGS. 25A-B shows Farnesene content in the ethylene/farnesene copolymers. F1: quantification of trimethyl groups; F2: quantification of vinylidene groups.

FIG. 26 shows the Molecular weight distribution (MWD) curves of ethylene/farnesene copolymers measured by 3D GPC, using IR detector.

FIG. 27 shows Mz as a function of comonomer content (mol %).

FIG. 28 shows CH₃/1000 C as a function of the farnesene content.

FIG. 29 shows an overlay of MWD curves of copolymers with 0.52 and 1.02 mol % farnesene.

FIG. 30 shows MWD curves of ethylene/farnesene copolymers measured by GPC 3D, using the viscometer detector.

FIG. 31 shows ¹³C NMR spectrum of ethylene/farnesene copolymers

FIG. 32 shows S3 as a function of Mn.

FIG. 33 shows TGA thermograms of the ethylene/farnesene copolymers.

FIG. 34 shows weight loss at T<250° C. as a function of farnesene content.

FIG. 35 shows DSC crystallization curve of ethylene/farnesene copolymers.

FIG. 36 shows DSC melting curve of ethylene/farnesene copolymers.

FIG. 37 shows CEF profiles of LDPE and ethylene/farnesene copolymers.

FIG. 38 shows soluble fraction amount as a function of farnesene content.

FIG. 39 shows CEF-MALS profile of LDPE and ethylene/farnesene copolymers.

FIG. 40 shows CEF-MALS profile of LDPE and ethylene/farnesene copolymers.

FIG. 41 shows complex viscosity at 170° C. of ethylene/farnesene copolymers.

### DETAILED DESCRIPTION

Embodiments disclosed herein generally relate to an ethylene-based polymer comprising at least one terpene comonomer, based on the total weight of the ethylene-based polymer.

The at least one terpene comonomer comprises 1 to 5 isoprene units, based on the total weight of the ethylene-based polymer. In one embodiment of the present invention, the at least one terpene comonomer is one single terpene comonomer, thereby forming an ethylene-based copolymer.

In alternative embodiments, the at least one terpene comonomer means two terpene comonomers, each one having the same or different isoprene unit(s), thereby forming an ethylene-based terpolymer. In such embodiments, the ethylene-based polymer disclosed in the present invention may be formed by reacting ethylene with a first comonomer to form a first polymer resin or prepolymer, which is then reacted with a second comonomer to prepare the final ethylene-based polymer, wherein the first and the second comonomer can be added in the same reactor or in different reactors.

The isoprene unit has the formula (C₅H₈). A terpene comonomer having a single isoprene unit is generally called as hemiterpene; a terpene comonomer having 2 isoprene units is generally called as monoterpene; a terpene comonomer having 3 isoprene units is generally called as sesquiterpene; a terpene comonomer having 4 isoprene units is generally called as diterpene; while a terpene comonomer having 5 isoprene units is generally called as sesterterpene.

The term “terpene” is used herein to include terpenoids, i.e., terpenes that are chemically-modified, such as by oxidation or rearrangement of the carbon skeleton. Besides, the term “terpenoids” may also be referred to as isoprenoids.

In an embodiment when the at least one terpene comonomer is a hemiterpene (one single isoprene unit), the comonomer may be selected from the group comprising isoprene, prenol or combinations thereof.

When the at least one terpene comonomer is a monoterpene, the comonomer may be selected from the group comprising limonene, myrcene, ocimene, geraniol, pinene, Δ3-carene, canfene, sabinene, terpinene, citral, citronellol, geraniol, lavandulol, linalool, terpineol, thymol, menthol, carvone, eucalyptol, perillaldehyde, thujone, thujene, borneol, camphor, camphene, carvacrol, pulegone, ascaridole, or combinations thereof.

When the at least one terpene comonomer is a sesquiterpene, the comonomer may be selected from the group comprising farnesene, farnesol, zingiberene, santalene, AR-curcumene, sesquifelandrene, cedrene, bisabolene, caryophyllene, gurjunene, cadinene, selinene, humulene, valencene, AR-diidroturmerona, AR-turmerol, bisabolol, cadinol, nerolidol, nerol, orto acetoxi bisabolol, sesquicineo, santalol, thujopsene, umbellulone, khushimol, or combinations thereof.

When the at least one terpene comonomer is a diterpene, the comonomer may be selected from the group comprising phytol, 9-geranyl-α-terpineol, sclareol, marrubiin, casbene, cafestol, kahweol, cembrene, taxadiene, taxol, or combinations thereof.

When the at least one terpene comonomer is a sesterterpene, the comonomer may be geranylfarnesol or derived thereof, like ophiobolin A, gascardic acid, and ceroplastol.

Most of the organic compounds listed above have different stereoisomers, having α or β forms, related to the location of one double bond. In the context of the present invention, such terpene comonomers may comprise either α or β forms, or even a combination thereof.

In a preferred embodiment, the at least one terpene comonomer comprises 1 to 3 comonomer units. In such embodiments, the at least one terpene comonomer may be preferably selected from isoprene, myrcene, Δ3-carene, ocimene, limonene, terpinene, sabinene, pulegone, farnesene, farnesol and combinations thereof. In a more preferred embodiment, the at least one terpene comonomer is selected from isoprene, α-myrcene, β-myrcene, α-ocimene, β-ocimene, α-farnesene, β-farnesene, or combinations thereof.

The at least one terpene comonomer is bio-based and it can be isolated or derived from terpene oils for use in the present invention. In one embodiment of the present invention, it is produced from renewable sources, such as sugarcane, from fermentation.

In the context of the present invention, the at least one terpene comonomer is present in the ethylene-based polymer in an amount ranging from 0.01 to 25 wt. %, based on the total weight of the ethylene-based polymer. In one embodiment, the at least one terpene comonomer is present in an amount from a lower limit selected from any one of 0.01 wt. %, 0.1 wt. % and 0.5 wt. %, to an upper limit selected from any one of 1 wt. %, 5 wt. %, 10 wt. %, 15 wt. %, 20 wt. % and 25 wt. %. In one preferred embodiment, the at least one terpene comonomer is present in an amount from 0.1 to 5 wt. %.

In one or more embodiments, the ethylene-based polymer of the present invention comprises one terpene comonomer and may further comprise a third comonomer selected from C₃-C₈ α-olefins, branched vinyl ester monomers and vinyl acetate. In some embodiments, the branched vinyl ester comonomers, if present, may be one of those included in U.S. Pat. No. 11,453,732 B2, herein incorporated by reference. For example, the branched vinyl ester comonomers may have the general chemical formula (I):

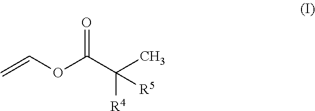

wherein R⁴ and R⁵ have a combined carbon number of 6 or 7.

Examples of branched vinyl ester comonomers may include monomers having the chemical structures, including derivatives thereof:

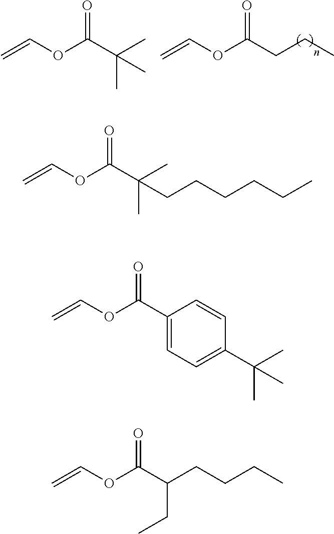

In one or more embodiments, branched vinyl ester comonomers may include monomers and comonomer mixtures containing vinyl esters of neononanoic acid, neodecanoic acid, and the like. In some embodiments, branched vinyl esters may include Versatic™ acid series tertiary carboxylic acids, including Versatic™ acid EH, Versatic™ acid 9 and Versatic™ acid 10 prepared by Koch synthesis, commercially available from Hexion™ chemicals.

In such embodiments wherein the third comonomer is comprised in the ethylene-based polymer, the third comonomer may be present in an amount up to 50 wt. %, based on the total weight of the ethylene-based polymer. Preferably, the third comonomer, when present in the ethylene-based polymer according to the present invention, may be in an amount from 0.1 to 40 wt. %, more preferably, in an amount from 1 to 30 wt. %.

The ethylene-based polymer of the present invention may have a melt flow index ranging from 0.1 to 100 g/10 min (2.16 kg/190° C.), measured according to ASTM D1238, preferably from 0.5 to 50 g/10 min, more preferably from 1 to 30 g/10 min and most preferably from 1 to 20 g/10 min.

In one or more embodiments, the ethylene-based polymer is a low-density polyethylene (LDPE) produced in a high-pressure reactor selected from autoclave reactor and tubular reactor. The density of the LDPE produced according to the present invention may vary from 0.910 to 0.925 g/cm³, preferably from 0.912 to 0.922 g/cm³, measured according to ASTM D792 Method B.

In one or more embodiments, the ethylene-based polymer may have a bio-based carbon content, as determined by ASTM D6866-18 Method B, in a range having a lower limit selected from any of 1%, 5%, 10%, and 20%, to an upper limit selected from any of 60%, 80%, 90%, and 100%, where any lower limit may be paired with any upper limit.

In one or more embodiments, the ethylene-based polymer produced under high-pressure conditions according to the present invention has a ratio between MwUC (weight average molecular weight measured based on the universal calibration) and MwCC (weight average molecular weight measured based on the conventional calibration) from 1 to 25. The same values apply to MzUC (Z average molecular weight measured based on the universal calibration)/MzCC ratio (Z average molecular weight measured based on the conventional calibration). Such result may be used as an indicative of the presence of long chain branches and the increase of molar mass promoted by it.

In the conventional calibration method, it is used a calibration curve that was built based on a set of polymer standards with narrow molecular weight distribution. The logarithm of molecular weight of a series of narrow standards are plotted against elution volume. In this method, the molecular weight averages obtained are relative to these standards (calibration curve) and the molecular weight relative to the polymer of interest can be calculated considering Mark-Houwink constants of sample and standard. The results are obtained from the IR5 detector.

The universal calibration method is a GPC analysis using a GPC instrument equipped with IR5 infrared detector and a four-capillary viscometry detector, both from Polymer Char. Data collection was performed using Polymer Char's software. The concentration measured by IR5 detector was calculated considering that the whole area of the chromatogram was equivalent to the elution of 100% of the mass injected.

The universal calibration method is based on the Mark-Houwink relationship ([η]=K Ma) that correlates the intrinsic viscosity with the molecular weight of the polymer. It is based on the assumption that the separation in the GPC columns is based on the hydrodynamic volume of the polymer rather than on its molar mass. Based on the obtained hydrodynamic volume, the elution volume can be determined.

The ethylene-based polymer according to the present invention may show number average molecular weights (Mn) of 1 to 10000 kDa, weight average molecular weights (Mw) of 1 to 20000 kDa. In one embodiment, Mw/Mn ratio (polydispersity index) varies from 1 to 60. In further embodiments, Mz (Z average molecular weight)/Mw ratio, which indicates the polydispersity in the high molecular weight region, may be up to 3 times higher than Mw/Mn ratio, wherein all the parameters were measured based on the universal calibration (UC).

In one or more embodiments, the ethylene-based polymer may have a long chain branching frequency LCBf, calculated by GPC analysis, ranging from 0 to 10, such as from a lower limit of any of zero, 0.5, 1, or 1.5 and an upper limit of any of 2, 4, 6, 8, or 10, where any lower limit may be paired with any upper limit.

The long chain branching average LCBf may be calculated from GPC analysis using a GPC instrument equipped with IR5 infrared detector and a four-capillary viscometry detector, both from Polymer Char. Data collection was performed using Polymer Char's software. The concentration measured by IR5 detector was calculated considering that the whole area of the chromatogram was equivalent to the elution of 100% of the mass injected. Average LCBf was then calculated according to:

$$LCBf = \frac{1000 {B}_{n} R}{{M}_{w}}$$

where R is the molar mass of the repeated unit and is calculated based on the contribution of monomer and comonomers, considering the mol percentage of each one, determined by NMR. M_{w} is the weight average molecular weight and is calculated according to the following equation by means of universal calibration:

$${M}_{w} = [ \frac{\sum ( {N}_{i} {M}_{i}^{2} )}{\sum ( {N}_{i} {M}_{i} )} ]$$

Average Bₙ constant is calculated according to:

$$g = {[ {( 1 + \frac{{B}_{n}}{7} )}^{1 / 2} + \frac{4 {B}_{n}}{9 π} ]}^{- 1 / 2}$$

Average g′ and g constants are calculated according to:

$${g}^{′} = \frac{{IV}_{Branched}}{{IV}_{Linear}}$$

$${g}^{′} = {g}^{ε}$$

ε is known as the viscosity shielding ratio and is assumed to be constant and equal to 0.7.

The intrinsic viscosity of the branched samples (IV_{branched}) may be calculated using the specific viscosity (ηₛₚ) from the viscometer detector as follows.

$${IV}_{branched} = \frac{{\sum }_{i} {( {η}_{sp} )}_{i} Δ {V}_{i}}{SA} \frac{1}{10 KIV}$$

where SA is sample amount, KIV is viscosity detector constant and the volume increment (ΔV) is a constant determined by the difference between consecutive retention volumes (ΔV=RVᵢ₊₁−RVᵢ).

The intrinsic viscosity of the linear counterpart (IVₗᵢₙₑₐᵣ) may be calculated using Mark-Houwink equation, whereas the Mark-Houwink constants are obtained from the intrinsic viscosity considering the concentration from Stacy-Haney method as follows.

The Stacey-Haney IV (IV_{SH}) is calculated based on Stacy-Haney concentration by

$${IV}_{{SH}_{i}} = \frac{1}{KIV} \frac{{η}_{{sp}_{i}}}{{C}_{{SH}_{i}}} ,$$

where C_{SH} is found from

$${C}_{SHi} = \frac{{( ln {η}_{rel} )}_{i} K}{{( hv )}_{i}^{a / a + 1}}$$

whereas ηᵣₑₗ is the relative viscosity (ηᵣₑₗ=ηₛₚ+1), (hv)ᵢ is the hydrodynamic volume at each elution volume slice from the universal calibration curve and the Mark-Houwink exponent, a, was defined as 0.725, reference value for a linear polyethylene homopolymer and the constant, K, is calculated according to:

$$K = \frac{\frac{SA}{Δ V}}{\frac{\sum {( ln {η}_{rel} )}_{i}}{{( hv )}_{i}^{a / a + 1}}}$$

From IV_{SH}_{ᵢ} the molecular weight (M_{SH}) on each elution volume slice is also obtained according to

$${M}_{{SH}_{i}} = \frac{{hv}_{i}}{{IV}_{{SH}_{i}}}$$

Plotting IV_{SH}_{ᵢ} versus M_{SH}_{ᵢ}, both in log scale, leads to Mark-Houwink constants k and a for the linear polymer. Finally, IVₗᵢₙₑₐᵣ may be calculated as:

IVₗᵢₙₑₐᵣ=kMᵥ^{a}

where Mᵥ is the viscosity average molecular weight by means of universal calibration and the concentration by IR5 infrared detector, and is calculated according to:

$${M}_{v} = {[ \frac{\sum ( {N}_{i} {M}_{i}^{a + 1} )}{\sum ( {N}_{i} {M}_{i} )} ]}^{1 {/}_{a}}$$

where Nᵢ is the number of ith molecules with molecular weight of Mᵢ. The Mᵢ is obtained considering the concentration by IR5 infrared detector and the hydrodynamic volume from the universal calibration

$$( {M}_{i} = \frac{{hv}_{i}}{\frac{1}{KIV} \frac{{η}_{{sp}_{i}}}{{C}_{{IR}_{i}}}} ) .$$

Mᵢ is plotted against the retention volume, the noisy extremes of the curve are removed and then extrapolated using a third order fit polynomial. The equation derived from this 3° order fit polynomial is used to calculate the Mᵢ as a function of retention volume.

In one or more embodiments, the ethylene-based polymers according to the present invention may have a long chain branching content, measured by ¹³CNMR, ranging from 0 to 10, such as a lower limit of any of 0, 0.2, 0.4, 0.6, 0.8, or 1 and an upper limit of any of 2, 4, 6, 8, or 10, where any lower limit may be paired with any upper limit.

In ¹³CNMR analysis, long chain branching (LCB) is defined as any branch with six or more carbons. Based on ¹³CNMR spectra, LCB content (B₆₊) in branched polymers is calculated from:

$${B}_{6 +} = {S}_{3 , Polymer} - {S}_{3 , terpene comonomer}$$

where the S₃ peak is positioned at 32.2 ppm on a ¹³CNMR spectrum. This method takes into account both branches (B₆₊) and the chain ends of the main chain, where the effect of the long branches in the terpene comonomer is corrected using its ¹³CNMR spectrum, and the effect of chain ends can also be corrected with GPC data.

In one or more embodiments, the ethylene-based polymers may have a melting temperature (Tₘ) measured according to ASTM D3418 by DSC in a range having a lower limit selected from any 20° C., 30° C., 40° C. and 50° C. to an upper limit selected from any of 130° C., 140° C., 150° C., 160° C., 170° C., 180° C., 190° C. and 200° C. where any lower limit may be paired with any upper limit.

In one or more embodiments, polymer compositions may have a crystallization temperature (T_{c}) measured according to ASTM D3418 by DSC in a range having a lower limit selected from any 20° C., 30° C., 40° C. and 50° C. and to an upper limit selected from any of 130° C., 140° C., 150° C., 160° C., 170° C., 180° C., 190° C. and 200° C. where any lower limit may be paired with any upper limit.

The present invention also relates to a method for preparing an ethylene-based polymer under a high-pressure system. The method comprises:
Feeding an ethylene stream to a polymerization reactor,
Feeding at least one terpene comonomer comprising 1 to 5 isoprene units to the polymerization reactor,
Perform a polymerization reaction in the presence of at least one free radical initiator at a pressure from 1100 to 3500 bar to produce an ethylene-based polymer,
Recover the ethylene-based polymer from the polymerization reactor.

The ethylene-based polymer produced by the method of the present invention comprises at least one terpene comonomer comprising 1 to 5 isoprene units added to the ethylene stream in an amount ranging from 0.01 to 10 wt. %, based on the total weight of the ethylene-based polymer. Preferably, the at least one terpene comonomer 1 to 3 isoprene units and in alternative embodiments it may be added in amounts ranging from 0.01 to 5 wt. %, or in amounts ranging from 0.1 to 1 wt. %, based on the total weight of the ethylene-based polymer.

In the context of the present invention, the polymerization reaction occurs in the presence of at least one initiator for radical polymerization capable of generating free radicals that initiate chain polymerization of comonomers and prepolymers in a reactant mixture. In one or more embodiments, radical initiators may include chemical species that degrade to release free radicals spontaneously or under stimulation by temperature, pH, or other trigger. Particularly, the at least one free radical initiator may be selected from oxygen, peroxide compounds, azo-compounds and Carbon-Carbon (“C—C”) free radical initiator.

In one or more embodiments, the at least one free radical initiator may include peroxides and bifunctional peroxide compounds, such as benzoyl peroxide; dicumyl peroxide; di-tert-butyl peroxide; tert-butyl cumyl peroxide; t-butyl-peroxy-2-ethyl-hexanoate; tert-butyl peroxypivalate; tertiary butyl peroxyncodecanoate; t-butyl-peroxy-benzoate; t-butyl-peroxy-2-ethyl-hexanoate; tert-butyl 3,5,5-trimethylhexanoate peroxide; tert-butyl peroxybenzoate; 2-ethylhexyl carbonate tert-butyl peroxide; 2,5-dimethyl-2,5-di(tert-butylperoxide) hexane; 1,1-di(tert-butylperoxide)-3,3,5-trimethylcyclohexane; 2,5-dimethyl-2,5-di(tert-butylperoxide) hexyne-3; 3,3,5,7,7-pentamethyl-1,2,4-trioxepane; butyl 4,4-di(tert-butylperoxide) valerate; di(2,4-dichlorobenzoyl) peroxide; di(4-methylbenzoyl) peroxide; peroxide di(tert-butylperoxyisopropyl)benzene; and the like.

The at least one free radical initiators may also include peroxide compounds such as 2,5-di(cumylperoxy)-2,5-dimethyl hexane, 2,5-di(cumylperoxy)-2,5-dimethyl hexyne-3,4-methyl-4-(t-butylperoxy)-2-pentanol, 4-methyl-4-(t-amylperoxy)-2-pentano 1,4-methyl-4-(cumylperoxy)-2-pentanol, 4-methyl-4-(t-butylperoxy)-2-pentanone, 4-methyl-4-(t-amylperoxy)-2-pentanone, 4-methyl-4-(cumylperoxy)-2-pentanone, 2,5-dimethyl-2,5-di(t-butylperoxy) hexane, 2,5-dimethyl-2,5-di(t-amylperoxy) hexane, 2,5-dimethyl-2,5-di(t-butylperoxy) hexyne-3,2,5-dimethyl-2,5-di(t-amylperoxy) hexyne-3, 2,5-dimethyl-2-t-butylperoxy-5-hydroperoxyhexane, 2,5-dimethyl-2-cumylperoxy-5-hydroperoxy hexane, 2,5-dimethyl-2-t-amylperoxy-5-hydroperoxyhexane, m/p-alpha, alpha-di[(t-butylperoxy)isopropyl]benzene, 1,3,5-tris(t-butylperoxyisopropyl)benzene, 1,3,5-tris(t-amylperoxyisopropyl)benzene, 1,3,5-tris(cumylperoxyisopropyl)benzene, di[1,3-dimethyl-3-(t-butylperoxy)butyl]carbonate, di[1,3-dimethyl-3-(t-amylperoxy)butyl]carbonate, di[1,3-dimethyl-3-(cumylperoxy)butyl]carbonate, di-t-amyl peroxide, t-amyl cumyl peroxide, t-butyl-isopropenylcumyl peroxide, 2,4,6-tri(butylperoxy)-s-triazine, 1,3,5-tri[1-(t-butylperoxy)-1-methylethyl]benzene, 1,3,5-tri-[(t-butylperoxy)-isopropyl]benzene, 1,3-dimethyl-3-(t-butylperoxy) butanol, 1,3-dimethyl-3-(t-amylperoxy) butanol, di(2-phenoxyethyl) peroxydicarbonate, di(4-t-butylcyclohexyl) peroxydicarbonate, dimyristyl peroxydicarbonate, dibenzyl peroxydicarbonate, di(isobornyl) peroxydicarbonate, 3-cumylperoxy-1,3-dimethylbutyl methacrylate, 3-t-butylperoxy-1,3-dimethylbutyl methacrylate, 3-t-amylperoxy-1,3-dimethylbutylmethacrylate, tri(1,3-dimethyl-3-t-butylperoxy butyloxy) vinyl silane, 1,3-dimethyl-3-(t-butylperoxy)butyl N-[1-{3-(1-methylethenyl)-phenyl}-1-methylethyl]carbamate, 1,3-dimethyl-3-(t-amylperoxy)butyl N-[1-{3 (1-methylethenyl)-phenyl}-1-methylethyl]carbamate, 1,3-dimethyl-3-(cumylperoxy))butyl N-[1-{3-(1-methylethenyl)-phenyl}-1-methylethyl]carbamate, 1,1-di(t-butylperoxy)-3,3,5-trimethylcyclohexane, 1,1-di(t-butylperoxy) cyclohexane, n-butyl 4,4-di(t-amylperoxy) valerate, ethyl 3,3-di(t-butylperoxy) butyrate, 2,2-di(t-amylperoxy) propane, 3,6,6,9,9-pentamethyl-3-ethoxycabonylmethyl-1,2,4,5-tetraoxacyclononane, n-buty 1-4,4OO-t-amyl-O-hydrogen-monoperoxy-succinate, 3,6,9, triethyl-3,6,9-trimethyl-1,4,7-triperoxynonane (or methyl ethyl ketone peroxide cyclic trimer), methyl ethyl ketone peroxide cyclic dimer, 3,3,6,6,9,9-hexamethyl-1,2,4,5-tetraoxacyclononane, 2,5-dimethyl-2,5-di(benzoylperoxy) hexane, t-butyl perbenzoate, t-butylperoxy acetate, t-butylperoxy-2-ethyl hexanoate, t-amyl perbenzoate, t-amyl peroxy acetate, t-butyl peroxy isobutyrate, 3-hydroxy-1,1-dimethyl t-butyl peroxy-2-ethyl hexanoate, OO-t-amyl-O-hydrogen-monoperoxy succinate, OO-t-butyl-O-hydrogen-monoperoxy succinate, di-t-butyl diperoxyphthalate, t-butylperoxy (3,3,5-trimethylhexanoate), 1,4-bis(t-butylperoxycarbo)cyclohexane, t-butylperoxy-3,5,5-trimethylhexanoate, t-butyl-peroxy-(cis-3-carboxy) propionate, allyl 3-methyl-3-t-butylperoxy butyrate, OO-t-butyl-O-isopropylmonoperoxy carbonate, OO-t-butyl-O-(2-ethyl hexyl) monoperoxy carbonate, 1,1,1-tris[2-(t-butylperoxy-carbonyloxy) ethoxymethyl]propane, 1,1,1-tris[2-(t-amylperoxy-carbonyloxy) ethoxymethyl]propane, 1,1,1-tris[2-(cumylperoxy-cabonyloxy) ethoxymethyl]propane, OO-t-amyl-O-isopropylmonoperoxy carbonate, di(4-methylbenzoyl) peroxide, di(3-methylbenzoyl) peroxide, di(2-methylbenzoyl) peroxide, didecanoyl peroxide, dilauroyl peroxide, 2,4-dibromo-benzoyl peroxide, succinic acid peroxide, dibenzoyl peroxide, di(2,4-dichloro-benzoyl) peroxide, and combinations thereof.

In one or more embodiments, the at least one free radical initiator may include azo-compounds such as azobisisobutyronitrile (AIBN), 2,2′-azobis(amidinopropyl) dihydrochloride, and the like, azo-peroxide initiators that contain mixtures of peroxide with azodinitrile compounds such as 2,2′-azobis(2-methyl-pentanenitrile), 2,2′-azobis(2methyl-butanenitrile), 2,2′-azobis(2-ethyl-pentanenitrile), 2-[(1-cyano-1-methylpropyl) azo]-2-methyl-pentanenitrile, 2-[(1-cyano-1-ethylpropyl) azo]-2-methyl-butanenitrile, 2-[(1-cyano-1-methylpropyl) azo]-2-ethyl, and the like, and combinations thereof.

In one or more embodiments, the at least one free radical initiator may include Carbon-Carbon (“C—C”) free radical initiators such as 2,3-dimethyl-2,3-diphenylbutane, 3,4-dimethyl-3,4-diphenylhexane, 3,4-diethyl-3,4-diphenylhexane, 3,4-dibenzyl-3,4ditolylhexane, 2,7-dimethyl-4,5-diethyl-4,5-diphenyloctane, 3,4-dibenzyl-3,4-diphenylhexane, and the like, and combinations thereof.

In one or more embodiments, the ethylene-based polymers in accordance with the present disclosure may be formed in the presence of at least one free radical initiators at a percent by weight of the total polymerization mixture (wt %) that ranges from a lower limit selected from one of 0.000001 wt %, 0.0001 wt %, 0.01 wt %, 0.1 wt %, 0.15 wt %, 0.4 wt %, 0.6 wt %, 0.75 wt % and 1 wt %, to an upper limit selected from one of 0.5 wt %, 1.25 wt %, 2 wt %, 4 wt %, and 5 wt %, where any lower limit can be used with any upper limit. Further, it is envisioned that the concentration of the free radical initiator may be more or less depending on the application of the final material.

The conversion during polymerization in high pressure polymerization systems, according to the present invention, which is defined as the weight or mass flow of the produced polymer divided by the weight of mass flow of monomers and comonomers may have a lower limit of any of 0.01%, 0.1%, 1%, 2%, 5%, 7%, 10% and a upper limit of any of 15%, 17%, 20%, 25%, 30%, 35%, 40%, 45%, 50%, 60%, 70%, 80%, 90%, 99% or 100%.

In one or more embodiments, the polymerization step is a single step or multiple steps. In the present disclosure, a single step means that the polymerization occurs in one single reactor, while the multiple steps means that the polymerization occurs in multiple reactors in series or in parallel. The ethylene stream and the at least one terpene comonomer may be fed to the reactor(s) simultaneously or the ethylene stream is fed first, and then, after the operation conditions are achieved, the at least one terpene comonomer is fed to the reactor(s).

The method in accordance with the present invention is carried out in a pressure varying from 1100 to 3500 bar, or preferably at pressure ranging from 1500 to 3500 bar. In further embodiments, the method is carried out at a temperature ranging from 150 to 350° C.

The ethylene-based polymer according to the present invention is suitable for extrusion coating film applications, being especially processable in high-speed extrusion coating machines. Due to good properties such as i) high degree of long chain branching and branches on branches, ii) broad molecular weight distribution and iii) presence of a high molecular weight fraction, many articles comprising the ethylene-based polymer may be produced, especially packaging, adhesives and footwears.

The following examples are merely illustrative and should not be interpreted as limiting the scope of the present disclosure.

### EXAMPLES

### Example 1: Evaluation of Free-Radical Copolymerization of Ethylene and Farnesene at Medium Pressures

Example 1 aimed just to evaluate whether farnesene monomer can be copolymerized with ethylene in free radical polymerization and its influence on the copolymer properties of the polymer, mainly the amount of unsaturation and degree of long chain branching (LCB). This Example was tested on a laboratory scale to assess the feasibility of the polymerization with farnesene at medium pressures.

### Polymer Synthesis

Prior to beginning experimentation, reactors were filled with 100 mL of dimethylcarbonate, 0.1 g of azobisazobutyronitrile (AIBN), and farnesene based on Table 1 conditions and sealed. Dimethylcarbonate was selected as the reaction media due to its low transfer to solvent coefficient.

TABLE 1
Reaction conditions for ethylene-farnesene copolymer synthesis

| | | | | | Maximum | Mass of |
|---|---|---|---|---|---|---|
| Reaction | AIBN | Farnesene | Temp | Ethylene | Pressure | polymer |
| ID | (g) | (g) | (° C.) | feed (L) | (bar) | (g) |
| 11022021- | 0.097 | 0 | 90 | 50 | 98.8 | 5.314 |
| 001 | | | | | | |
| 12012021- | 0.108 | 0.057 | 90 | 50 | 104.7 | 5.239 |
| 002 | | | | | | |
| 02162022- | 0.102 | 0.98 | 90 | 50 | 106.3 | 0.863 |
| 002 | | | | | | |
| 02162022- | 0.104 | 2.045 | 90 | 50 | 107 | 0.372 |
| 003 | | | | | | |

Once nitrogen purges were completed, 50 L of ethylene was fed into the reactors as measured by the MFC at 1500 ml/min. After ethylene filling, the temperature was set to increase to 90° C. and the reactors were monitored for four hours to allow the polymerization to occur.

Once the reaction time was completed, the system was cooled to 30° C., vented, and three nitrogen purge cycles were completed. The polymer was removed from the reactor and dried under vacuum, and the final weight of polymer collected was recorded in Table 1.

### Polymer Characterization

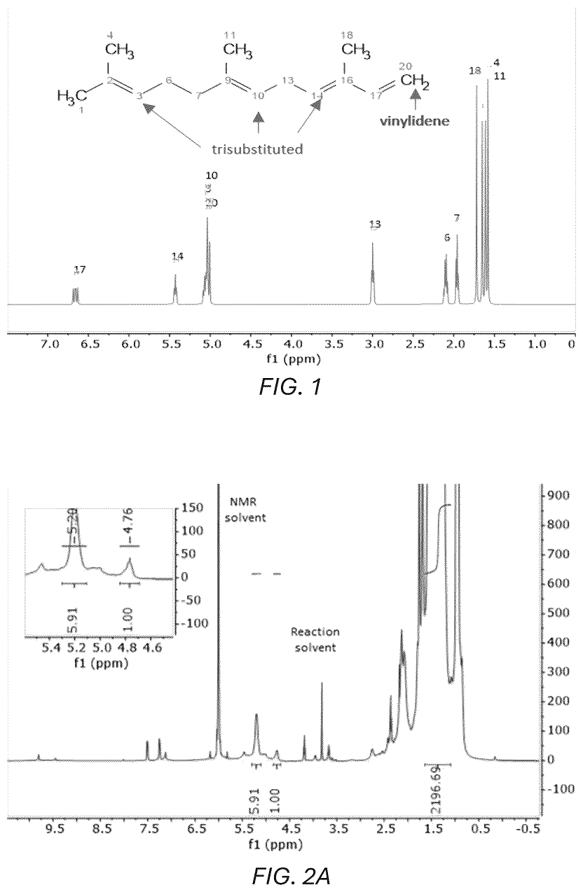

The ethylene/farnesene copolymers were analyzed by 1H NMR to determine the amount of farnesene incorporated. FIG. 1 shows the farnesene molecular structure with the 1H assignments and the correspondent peaks in a simulated 1H NMR spectrum of the molecule (from MNova).

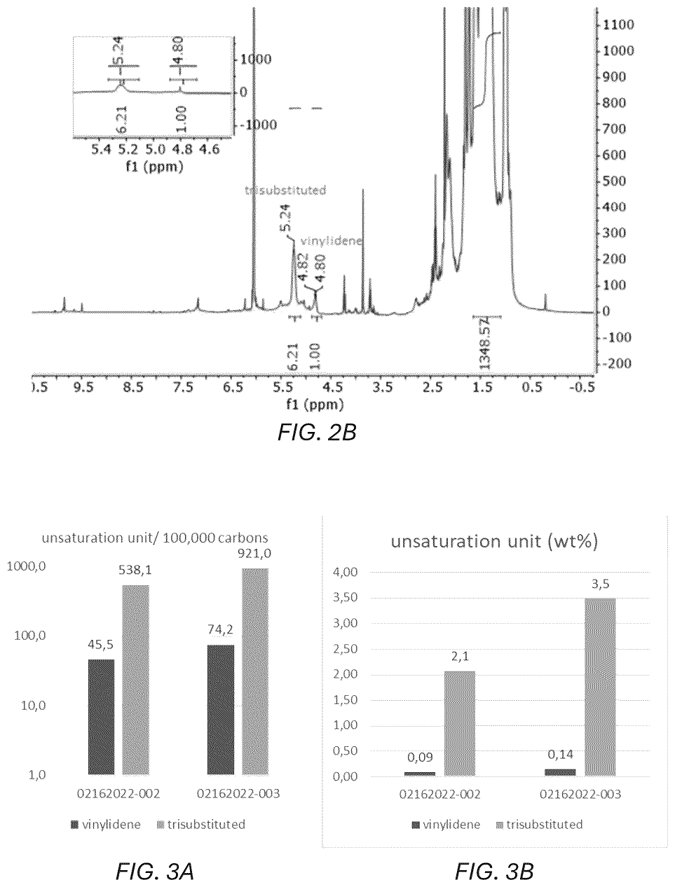

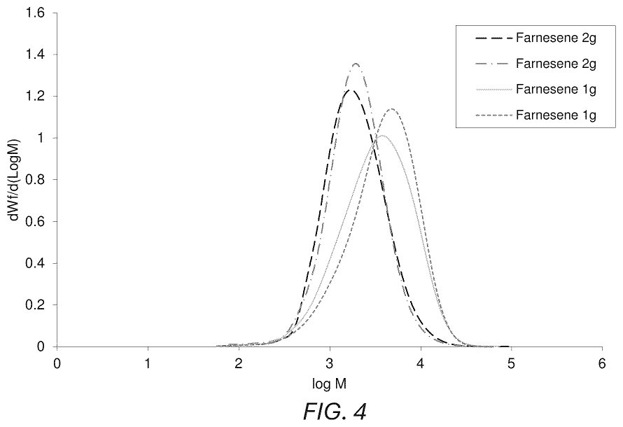

Presence of farnesene was not detected in samples with less than 0.98 g farnesene in the reaction media. FIGS. 2A and 2B show the 1H NMR spectra of two ethylene/farnesene copolymers with 0.98 and 2 g farnesene in the reaction media, respectively. The peaks attributed to the unsaturations and to the solvents are visible in these spectra. The peak at around 4.8 ppm is attributed to the vinylidene group and the one at around 5.2 ppm is attributed to the three unsaturations of the farnesene molecule (trisubstituted as indicated in FIG. 2). The unsaturation per 100,000 C was calculated based on these two peaks and the results are shown in FIG. 3A and the unsaturation unit (wt. %) results are shown in FIG. 3B. Considering 27 as the molar mass of the vinylidene group and 55 for the trisubstituted groups, the farnesene content in weight % was calculated and the results are shown in FIG. 4 and Table 2.

Although in the farnesene monomer the ratio trisubstituted/vinylidene is 3 to 1, in the polymer this ratio is 12 to 1 as indicated in FIG. 4. This may be an indication that farnesene is being incorporated to the polymer chain through the vinylidene group. No significant change in the degree of LCB of the copolymers were observed through NMR analysis, which is a consequence of the low polymerization pressure used in Example 1. Nevertheless, these data indicates that, at polymerization pressures closer to industrial conditions, the unsaturations observed in such sample will polymerize with ethylene, thus leading to a branch-on-branch structure.

The copolymers were also characterized by DSC and GPC and the results are shown in Table 2. The GPC experiments were carried out in a gel permeation chromatography coupled with an infrared detector and a four-bridge capillary viscometer (DV). The results shown in Table 2 are the ones obtained with the viscometer detector. The DSC data were obtained using cooling and heating rates of 10° C./min.

TABLE 2
Ethylene/farnesene copolymers characterization

| | 11022021- | 12012021- | 02162022- | 02162022- |
|---|---|---|---|---|
| Reaction ID | 001 | 002 | 002 | 003 |
| Farnesene (g) | 0 | 0.057 | 0.98 | 2.045 |
| Farnesene(wt %) | 0 | n.d. | 2.1 | 3.5 |
| Farnesene | 0 | n.d. | 0.293 | 0.494 |
| (mol %) | | | | |
| Tc (° C.) | n.d. | 107.6 | 103.7 | 97.9 |
| ΔHc (J/g) | n.d. | 162 | 97 | 121 |
| Tm2 (° C.) | n.d. | 116/113 | 111/109 | 106/103 |
| ΔHm(J/g) | n.d. | 150 | 97 | 125 |
| Mw (g/mol) | 13300 | n.d | 4900 | 2550 |
| Mn (g/mol) | 10900 | n.d. | 2150 | 1450 |
| Mw/Mn | 1.8 | n.d. | 2.3 | 1.8 |

n.d.: not detected

FIG. 4 shows the molecular weight distribution curves of two ethylene/farnesene copolymers, measured in duplicate. The sample with higher amount of farnesene incorporated shows lower molecular weight and lower polidispersity. Good agreement was observed between the results of the duplicates. Compared with a LDPE synthesized under similar conditions, Table 1, the ethylene/farnesene copolymers showed lower molecular weight, Table 2.

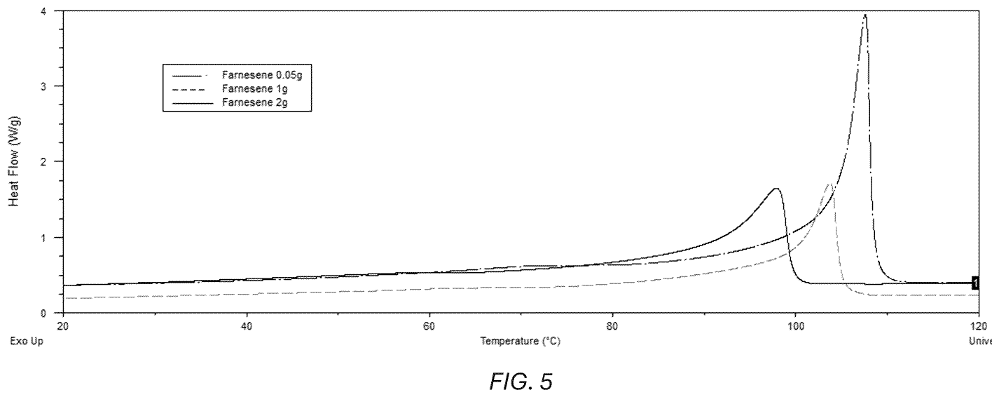

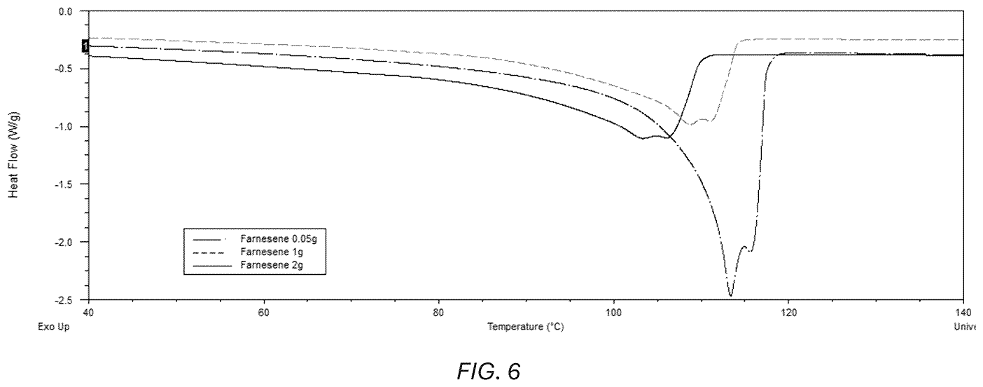

FIGS. 5 and 6 show the crystallization and melting thermograms of the ethylene/farnesene copolymers, respectively. As the content of farnesene increases, the crystallization and melting temperatures decrease, which has been usually observed for other comonomers in this type of copolymerization.

In the melting curves, two distinct peaks are observed, indicating that farnesene incorporation is not homogenous along the polymer chain. The peak at higher temperature is related to the less modified ethylene sequences that present higher crystal thickness. The peak at lower temperature is related to the more modified chain segments that present lower crystal thickness. As the farnesene amount increases, the difference in the intensity between the two peaks decreases and the endotherm gets broader, indicating a more heterogeneous crystal size distribution.

To conclude, it was observed that in the polymerization conditions tested, i.e., at medium pressure, farnesene copolymerized with ethylene. Farnesene incorporation was evidenced by 1H NMR characterization. High levels of unsaturations were detected. LCB content did not change due to low polymerization pressures.

### Example 2: Evaluation of Free-Radical Copolymerization of Ethylene and Myrcene at Medium Pressures

The objective of this example was just to evaluate whether myrcene monomer can be copolymerized with ethylene in free radical polymerization and its influence on the copolymer properties, mainly the amount of unsaturation, molecular weight, and thermal properties. Example 2 was tested on a laboratory scale to assess the feasibility of the polymerization with myrcene at medium pressures.

### Polymer Synthesis

Prior to the experiments, reactors were filled with 100 mL of dimethylcarbonate, approximately 0.1 g azobisisobutyronitrile (AIBN), and myrcene, based on Table 3 conditions, and sealed. Dimethylcarbonate was selected as the reaction media due to its low transfer to solvent coefficient.

TABLE 3
Reaction conditions for ethylene-myrcene copolymer synthesis

| | | | | | Maximum | Mass of |
|---|---|---|---|---|---|---|
| Reaction | AIBN | Myrcene | Temp | Ethylene | Pressure | polymer |
| ID | (g) | (g) | (° C.) | feed (L) | (bar) | (g) |
| 11022021- | 0.097 | 0 | 90 | 50 | 98.8 | 5.314 |
| 001 | | | | | | |
| 07132022- | 0.103 | 0.053 | 90 | 50 | 103.9 | 4.126 |
| 002 | | | | | | |
| 07132022- | 0.102 | 0.097 | 90 | 50 | 104.4 | 2.749 |
| 001 | | | | | | |
| 07012022- | 0.101 | 0.263 | 90 | 50 | 107.9 | 0.61 |
| 001 | | | | | | |
| 07012022- | 0.099 | 0.508 | 90 | 50 | 107.5 | 0.108 |
| 002 | | | | | | |
| 07012022- | 0.099 | 0.989 | 90 | 50 | 102.4 | 0 |
| 003 | | | | | | |

Once nitrogen purges were completed, 50 L of ethylene was fed into the reactors as measured by the MFC at 1500 ml/min. After ethylene filling, the temperature was set to increase to 90° C. and the reactors were monitored for four hours to allow the polymerization to occur. Once the reaction time was completed, the system was cooled to 30° C., vented, and three nitrogen purge cycles were completed. The polymer was removed from the reactor and dried under vacuum, and the final weight of polymer collected was recorded in Table 4.

### Polymer Characterization

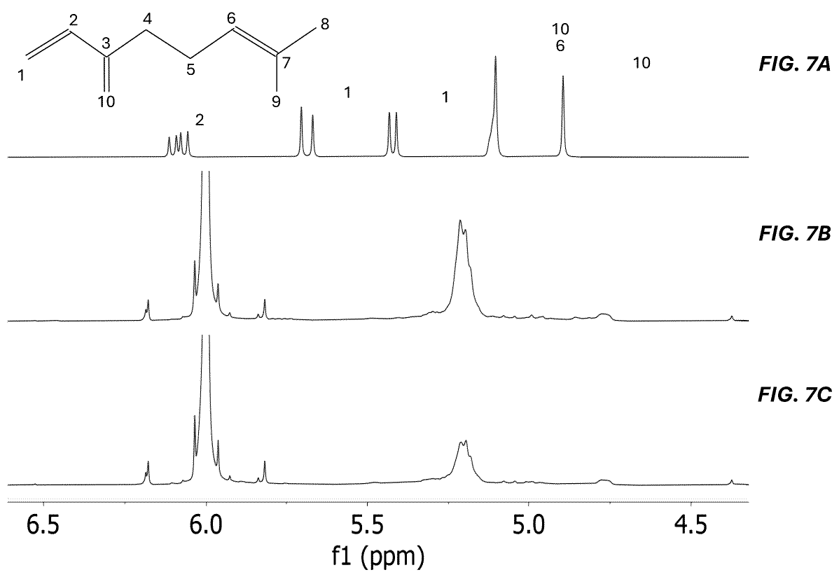

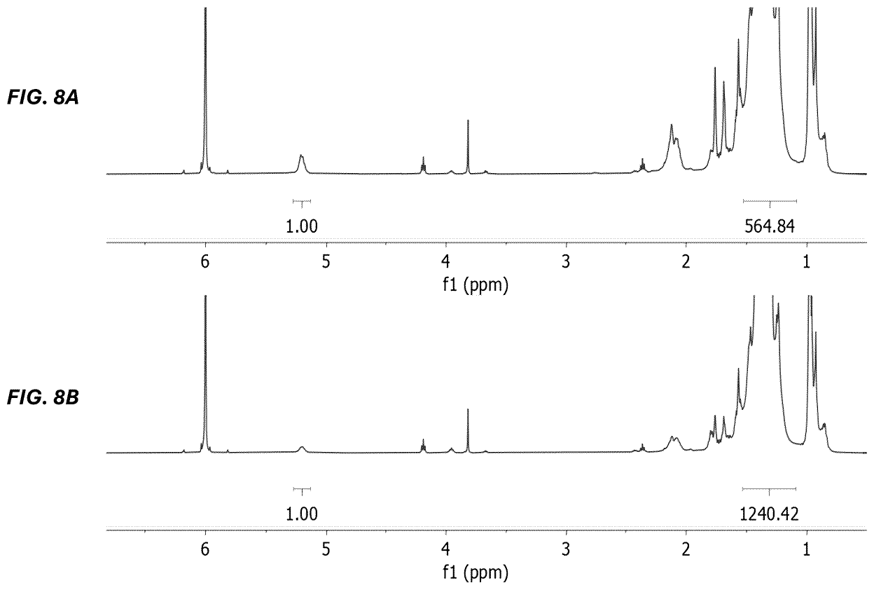

The ethylene/myrcene copolymers were analyzed by 1H NMR to determine the amount of myrcene incorporated. FIG. 7A shows the myrcene molecular structure with the 1H assignments and the correspondent peaks in a simulated 1H NMR spectrum of the molecule (from MNova). FIGS. 7B and 7C show the 1H NMR spectra of two ethylene/myrcene copolymers with 0.097 g and 0.053 g of myrcene, respectively, in the reaction media. The amount of myrcene incorporated in the copolymer was obtained by taking in account the peaks indicated in FIGS. 8A and 8B and whose integration areas are shown in Table 4.

TABLE 4
Myrcene content in the ethylene/myrcene copolymers

| | | |
|---|---|---|
| Myrcene in the | ¹H NMR | Weight |

| reaction media (g) | Myrcene | [EEEEE] | % |
|---|---|---|---|
| 0.053 | 1 | 1240.42 | 0.8 |
| 0.097 | 1 | 564.84 | 1.7 |

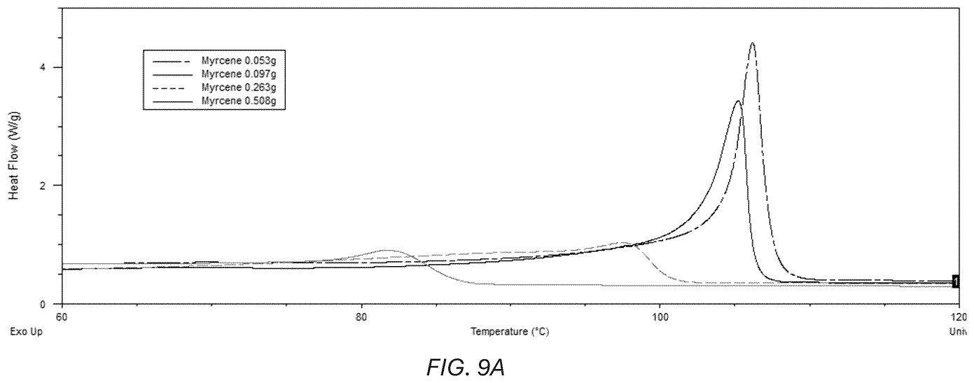

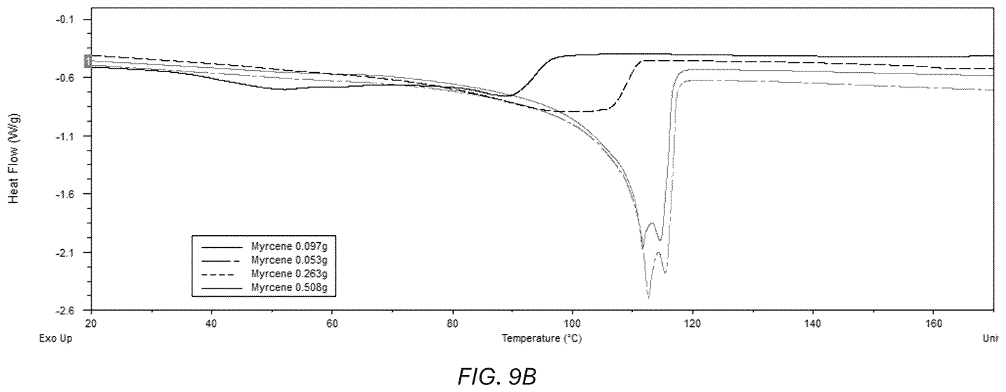

The copolymers were also characterized by DSC and GPC and the results are shown in Table 5. The DSC data were obtained using cooling and heating rates of 10° C./min. FIGS. 9A and 9B show the crystallization and melting thermograms of the ethylene/myrcene copolymers, respectively. As the content of myrcene increases, the crystallization and melting temperatures decrease, which has been usually observed for other comonomers in this type of copolymerization. [3] In the melting curves, the samples with lower amount of myrcene show two distinct peaks in the temperature range between 9° and 120° C. The peak at higher temperature is related to the less modified ethylene sequences that present higher crystal thickness. The peaks at lower temperatures are related to the more modified chain segments that present lower crystal thickness. Samples with higher amount of myrcene show very broad endotherms shifted to lower temperatures, indicating a more heterogeneous crystal size distribution. The higher the amount of myrcene, the lower the temperature and crystallinity.

The GPC experiments were carried out in a gel permeation chromatography coupled with an infrared detector and a four-bridge capillary viscometer (DV). The results shown in Table 5 are obtained with the viscometer detector. Only three samples were analyzed because the GPC was out of work. Based on these three samples, it is possible to observe that the molecular weight decreases as the amount of myrcene increases.

TABLE 5
Ethylene/myrcene copolymers characterization

| | 11022021- | 07132022- | 07132022- | 07012022- | 07012022- |
|---|---|---|---|---|---|
| Reaction ID | 001 | 002 | 001 | 001 | 002 |
| Myrcene (g) | 0 | 0.053 | 0.097 | 0.263 | 0.508 |
| Myrcene | 0 | 0.8 | 1.7 | n.a. | n.a. |
| (wt %) | | | | | |
| Myrcene | 0 | 0.165 | 0.354 | n.a. | n.a. |
| (mol %) | | | | | |
| Tc (° C.) | n.a. | 106.2 | 105.2 | 97.5/88.5 | 81.7/50 |
| □Hc (J/g) | n.a. | 164 | 150 | 127 | 134 |
| Tm2 (° C.) | n.a. | 115.5/112.7 | 114.6/111.7 | 99.3 | 89/51 |
| □Hm(J/g) | n.a | 145 | 138 | 132 | 115 |
| Mw (g/mol) | 13300 | n.a. | n.a. | 4450 | 2500 |
| Mn (g/mol) | 10900 | n.a. | n.a. | 2550 | 1700 |
| Mw/Mn | 1.8 | n.a. | n.a. | 1.76 | 1.45 |

n.a.—not analyzed.

As a conclusion, it was observed that in the polymerization conditions tested, i.e., at medium pressures, myrcene copolymerized with ethylene. Myrcene incorporation was evidenced by 1H NMR characterization.

### Example 3: Evaluation of Free-Radical Copolymerization of Ethylene and Isoprene at Medium Pressures

The objective of this example was just to evaluate whether isoprene monomer can be copolymerized with ethylene in free radical polymerization and its influence on the copolymer properties, mainly the amount of unsaturation, molecular weight, and thermal properties. Example 3 was tested on a laboratory scale to assess the feasibility of the polymerization with isoprene at medium pressures.

### Polymer Synthesis

Prior to the experiments, reactors were filled with 100 mL of dimethylcarbonate, approximately 0.1 g azobisisobutyronitrile (AIBN), and isoprene based on Table 6 conditions and sealed. Dimethylcarbonate was selected as the reaction media due to its low transfer to solvent coefficient.

TABLE 6
Reaction conditions for ethylene-isoprene copolymer synthesis

| | | | | | Maximum | Mass of |
|---|---|---|---|---|---|---|
| Reaction | AIBN | Isoprene | Temp | Ethylene | Pressure | polymer |
| ID | (g) | (g) | (° C.) | feed (L) | (bar) | (g) |
| 11022021- | 0.097 | 0 | 90 | 50 | 98.8 | 5.314 |
| 001 | | | | | | |
| 10032022- | 0.103 | 1.005 | 90 | 50 | 101.8 | 0 |
| 001 | | | | | | |
| 10032022- | 0.103 | 0.507 | 90 | 50 | 101.9 | 0.002 |
| 002 | | | | | | |
| 10032022- | 0.103 | 0.251 | 90 | 50 | 93.9 | 1.344 |
| 003 | | | | | | |
| 11042022- | 0.101 | 0.101 | 90 | 50 | 102.2 | 2.672 |
| 001 | | | | | | |
| 11042022- | 0.1 | 0.057 | 90 | 50 | 100.4 | 4.621 |
| 002 | | | | | | |
| 11042022- | 0.101 | 0.025 | 90 | 50 | 94.1 | 5.983 |
| 003 | | | | | | |

Once nitrogen purges were completed, 50 L of ethylene was fed into the reactors as measured by the MFC at 1500 ml/min. After ethylene filling, the temperature was set to increase to 90° C. and the reactors were monitored for four hours to allow the polymerization to occur. Once the reaction time was completed, the system was cooled to 30° C., vented, and three nitrogen purge cycles were completed. The polymer was removed from the reactor and dried under vacuum, and the final weight of polymer collected was recorded in Table 7.

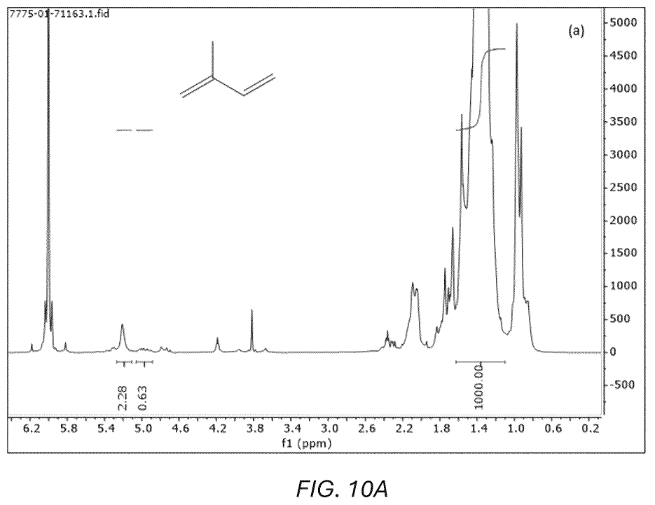

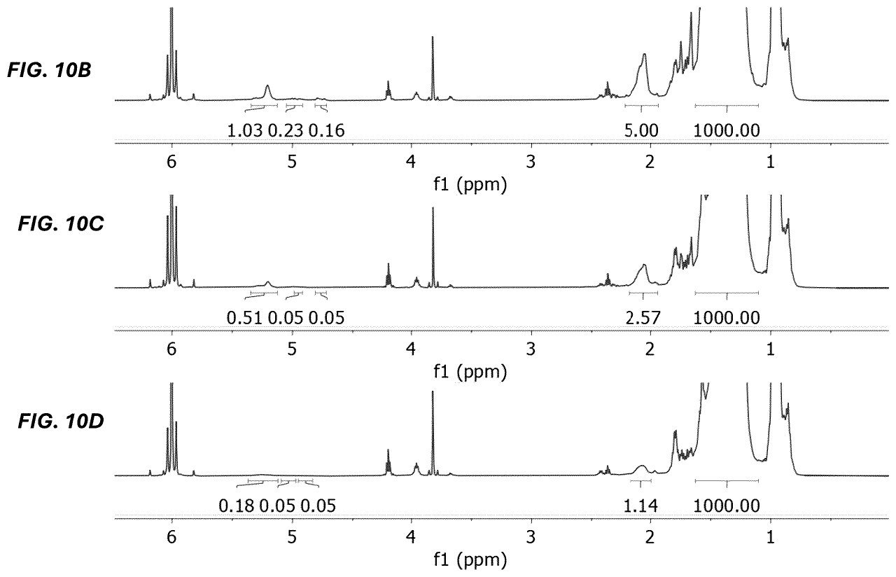

The ethylene/isoprene copolymers were analyzed by 1H NMR to determine the amount of isoprene incorporated. FIGS. 10A, 10B, 10C and 10D show the 1H NMR spectra of four ethylene/isoprene copolymers with 0.251 g, 0.101 g, 0.057 g, and 0.025 g of isoprene, respectively, in the reaction media. The amount of isoprene incorporated in the copolymer was obtained by taking in account the peaks indicated in FIGS. 10A-D.

TABLE 7
Isoprene content in the ethylene/isoprene copolymers

| Isoprene in the | Weight % |
|---|---|
| reaction media (g) | isoprene |
| 0.251 | 2.5 |
| 0.101 | 1.1 |
| 0.057 | 0.5 |
| 0.025 | 0.2 |

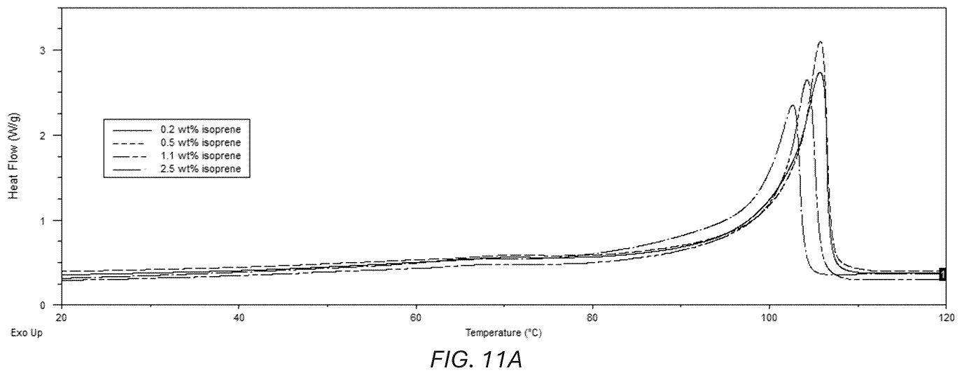

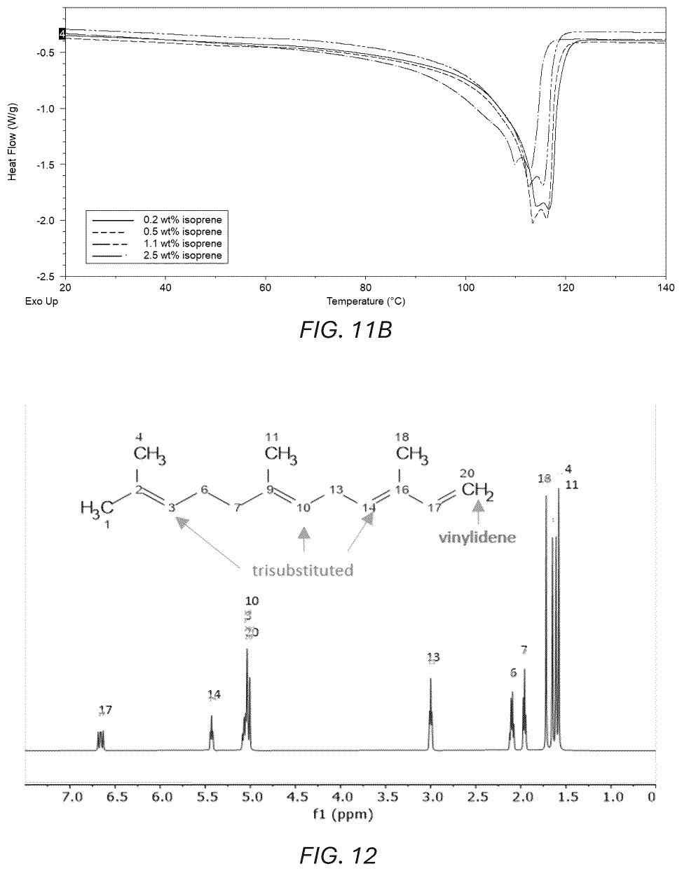

The copolymers were also characterized by DSC and GPC and the results are shown in Table 8. The DSC data were obtained using cooling and heating rates of 10° C./min. FIGS. 11A and B show the crystallization and melting thermograms of the ethylene/isoprene copolymers, respectively.

As the content of isoprene increases, the crystallization and melting temperatures decrease, which has been usually observed for other comonomers in this type of copolymerization. In the melting curves, the samples show two distinct peaks in the temperature range between 10° and 120° C. The peak at higher temperature is related to the less modified ethylene sequences that present higher crystal thickness. The peaks at lower temperatures are related to the more modified chain segments that present lower crystal thickness. The sample with the highest amount of isoprene shows a very broad endotherm shifted to lower temperatures, indicating a more heterogeneous crystal size distribution. The higher the amount of isoprene, the lower the temperature and crystallinity.

The GPC experiments were carried out in a gel permeation chromatography coupled with an infrared detector and a four-bridge capillary viscometer (DV), both from PolymerChar. The results shown in Table 3 are obtained with the viscometer detector.

TABLE 8
Ethylene/isoprene copolymers characterization

| | Reaction ID | | | | | | |
|---|---|---|---|---|---|---|---|
| | 11022021- | 10032022- | 10032022- | 10032022- | 11042022- | 11042022- | 11042022- |
| | 001 | 001 | 002 | 003 | 001 | 002 | 003 |
| Isoprene | 0 | 1.005 | 0.057 | 0.251 | 0.101 | 0.057 | 0.025 |
| (g) | | | | | | | |
| Isoprene | 0 | n.a. | n.a. | 2.5 | 1.1 | 0.5 | 0.2 |
| (wt %) | | | | | | | |
| Isoprene | 0 | n.a. | n.a. | 1.00 | 0.49 | 0.22 | 0.09 |
| (mol %) | | | | | | | |
| Tc (° C.) | n.a. | n.a. | n.a. | 102.63/65.46 | 104.23 | 105.74 | 105.71 |
| DHc | n.a. | n.a. | n.a. | 112.36/24.844 | 141.96 | 147.92 | 148.94 |
| (J/g) | | | | | | | |
| Tm₂ | n.a. | n.a. | n.a. | 109.89 | 112.73/115.42 | 113.43/116.29 | 114.15/116.64 |
| (° C.) | | | | | | | |
| DHm(J/g) | n.a | n.a. | n.a. | 144.38 | 133.27 | 141.95 | 139.02 |
| Mw | 13300 | n.a. | n.a. | 7450 | 11750 | 14050 | 14050 |
| (g/mol) | | | | | | | |
| Mn | 7400 | n.a. | n.a. | 3450 | 5250 | 7650 | 7250 |
| (g/mol) | | | | | | | |
| Mw/Mn | 1.80 | n.a. | n.a. | 2.17 | 2.23 | 1.83 | 1.95 |

n.a.— not analyzed

To conclude, in the polymerization conditions tested, i.e., at medium pressures, isoprene copolymerized with ethylene. Isoprene incorporation was evidenced by 1H NMR characterization.

### Example 4: Ethylene and Farnesene in a Continuous High-Pressure Polymerization

Continuous high-pressure polymerizations of ethylene with farnesene was performed on a mini plant used for polymer synthesis at high pressures and temperatures (up to 3000 bar and 300° C.). The initiator used was oxygen.

Table 9 shows a summary of the polymerization conditions and results.

TABLE 9
Ethylene/farnesene polymerization conditions.

| Sample | 1 | 2 | 3 | 4 | 5 |
|---|---|---|---|---|---|
| Initiator | O₂ | O₂ | O₂ | O₂ | O₂ |
| X_{O2} (molppm) | 0 | 16 | 13 | 7 | 4 |
| X_{farnesene}(mol %) | 0 | 0.15 | 0.10 | 0.05 | 0 |
| T_{1, reactor} (° C.) | 213.8 | 231.9 | 234.9 | 234.3 | 224.9 |
| T_{2, reactor} (° C.) | 221.4 | 237.2 | 237.2 | 236.3 | 236.9 |
| T_{avg, reactor} (° C.) | 217.6 | 234.5 | 236.1 | 235.3 | 230.9 |
| T_{jacket} (° C.) | 234.5 | 244.3 | 244.2 | 244.2 | 243.2 |
| m_{sample wet} (g) | 0.69 | 12.5 | 12.15 | 7.57 | 35.79 |
| tₛₐₘₚₗₑ (min) | 15 | 15 | 15 | 15 | 15 |
| X_{wet} (wt %) | 0.14 | 2.47 | 2.41 | 1.51 | 7.16 |

Sample 1 was intended to be an LDPE reference without conversion, but the temperature was chosen too low. Therefore, sample 5 should be a better reference though it could be affected by fouling and the conversion is a little too high.

The farnesene content of 0.15 mol % helped to initiate the reaction (temperatures inside the reactor increased). Three farnesene copolymer samples were synthesized and tried to keep the temperature and conversion as constant as possible. For sample 4, the collecting bag ruptured and some of the polymer sample (probably 1 g or a few grams) was not collected in the bag, but in the container holding the bag. This polymer was not transferred to the collecting bag to ensure the sample's purity. But the sample mass and hence the conversion of sample 4 should be a bit higher than measured.

### Samples Characterization

Before analysis, the samples were submitted to a purification and drying process to eliminate the residual monomers.

The ethylene/farnesene copolymers were analyzed by 13C and 1H NMR to determine the amount of farnesene incorporated, the amount of unsaturation and long chain branching (LCB) in the copolymers. FIG. 12 shows the farnesene molecular structure with the 1H assignments and the correspondent peaks in a simulated 1H NMR spectrum of the molecule (from MNova).

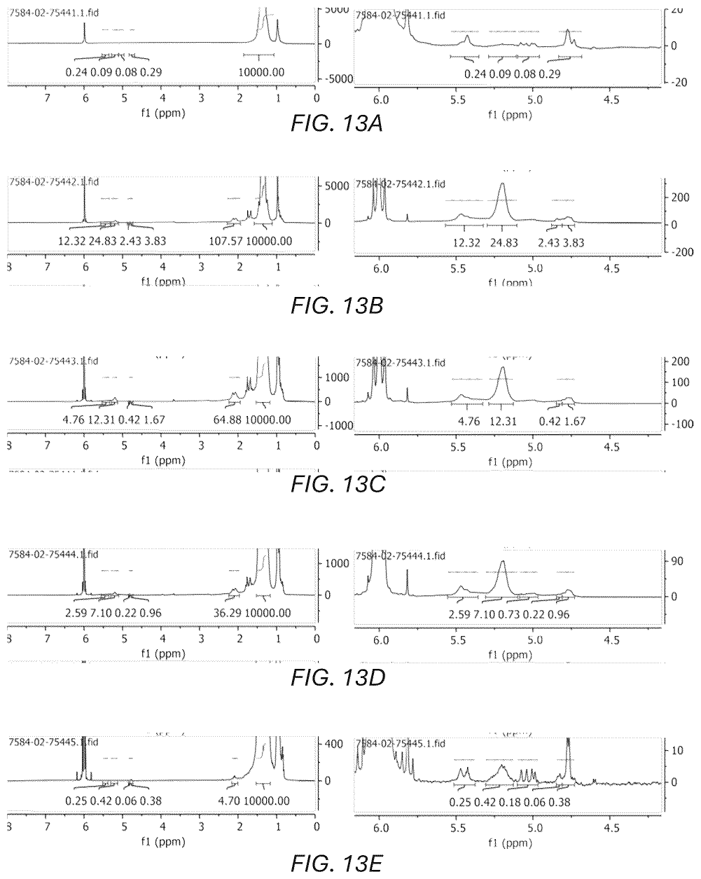

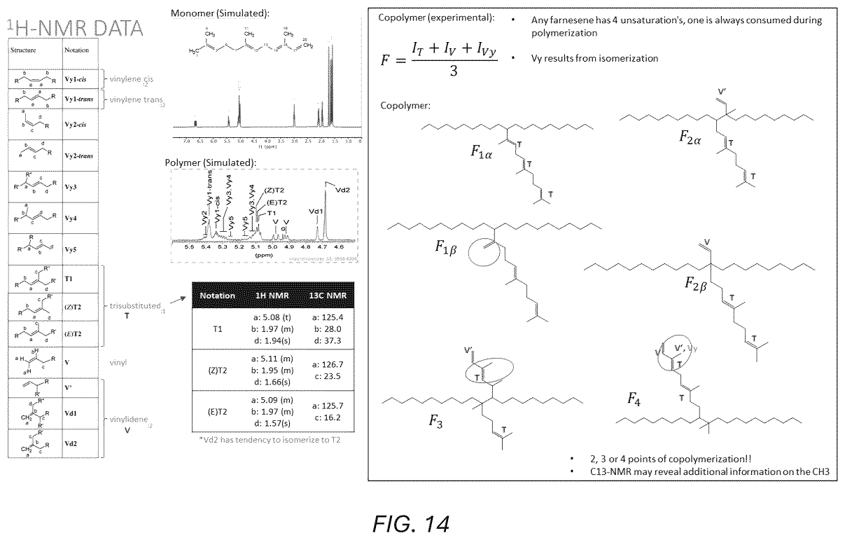

FIG. 13 shows the 1H NMR spectra of the two LDPE (FIGS. 13A and 13E) and the 3 ethylene/farnesene copolymers (FIGS. 13B-13D), where samples 1-5 are shown from top to bottom. FIG. 14 describes peak assignments and the different ways that farnesene can add into the polymer backbone.

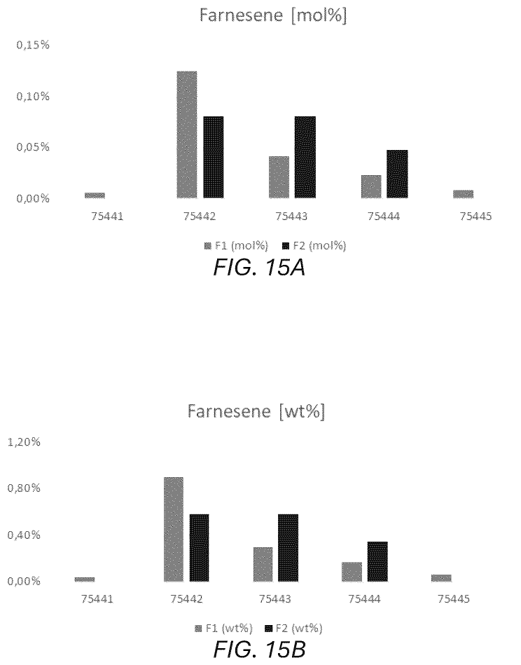

The peaks (doublet of doublets) at around 4.9-5 ppm are attributed to the vinyl termination groups and the one at around 5.1 ppm is attributed to the trisubstituted unsaturated carbons from the farnesene molecule, as shown in FIG. 14. The unsaturation degree per 1000 C was calculated based on these two peaks integrals. Considering 27 as the molar mass of the vinylidene group and 55 for the trisubstituted groups, the farnesene content in weight % was calculated and the results are shown in FIG. 15. Such calculations consider that a single unsaturation of farnesene is consumed during the polymerization; in a case that more unsaturations are consumed, the farnesene content determined by 1H-NMR is underestimated.

This is going to be a limitation on the method, as saturated groups in the copolymer (CH2, CH3) mix up with the saturated groups of the PE itself. This fact is confirmed by the increasing on the CH3 peak at 16.5 and 18 ppm, assigned to saturated methyl branches in different vicinity. In FIGS. 15A and 15B, F1 represents the amount of farnesene in mol % and wt %, respectively, incorporated through the vinylidene unsaturation (as represented in FIG. 14) and quantified using 3 trisubstituted group assignments. F2 is also represented in FIG. 14 and was quantified using the vinylidene group assignments in addition to 2 trisubstituted ones. The total amount of farnesene is the sum of F1 and F2 and is shown in Table 10.

TABLE 10
Farnesene content calculated using ¹H NMR.

| | | Farnesene | Farnesene |
|---|---|---|---|
| | Farnesene | in the | in the |
| | in the feed | copolymer | copolymer |
| Sample | (mol %) | (mol %) | (wt %) |
| 1 (75441) | 0 | 0 | 0 |
| 2 (75442) | 0.15 | 0.2 | 1.48 |
| 3 (75443) | 0.10 | 0.12 | 0.88 |
| 4 (75444) | 0.05 | 0.07 | 0.51 |
| 5 (75445) | 0 | 0 | 0 |

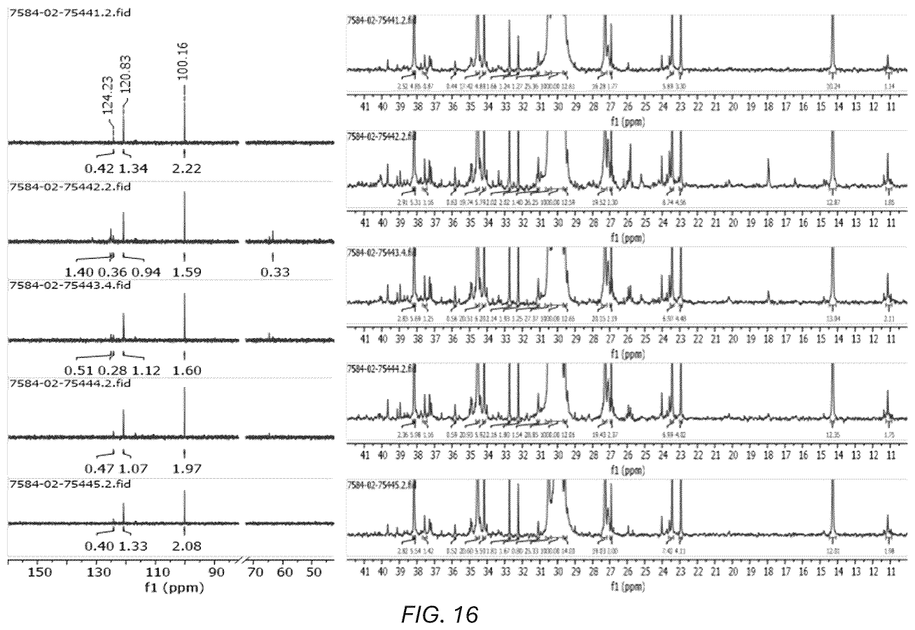

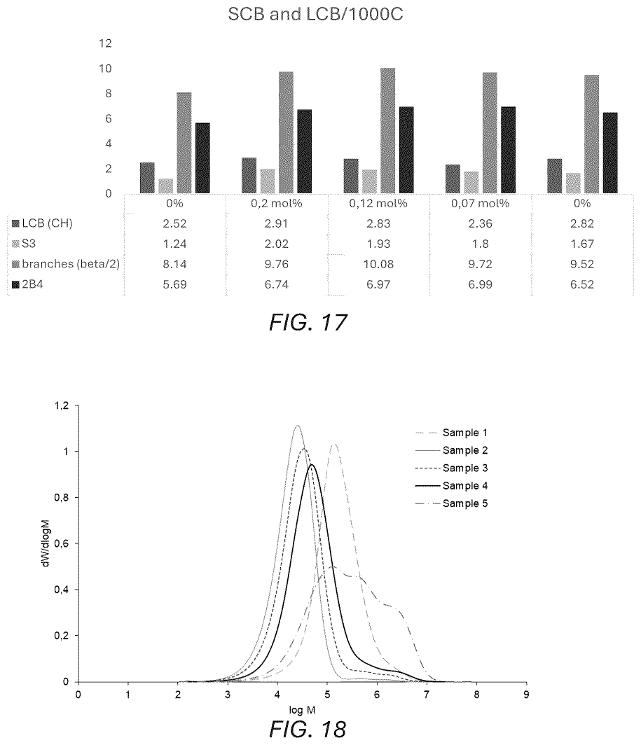

The branching content (short and long chain branches) were calculated through 13C NMR (FIG. 16), by integrating the peaks described in Table 11. Branch distribution of each sample is presented in FIG. 17. LCB and S3 can be used to estimate the amount of long chain branching in the samples, however, S3 is influenced by the chain length. Thus, when there is significant variation among the molecular weights of the samples, it is most appropriate to use LCB to estimate the amount of long chain branching. In the ethylene/farnesene copolymers, small differences in farnesene content are sufficient to increase the amount of LCB, as can be observed in FIG. 17.

TABLE 11
¹³C NMR peak assignments.

| Branch | Chemical Shift (ppm) | Description |
|---|---|---|
| LCB | 38.2 | CH of branches ≥6 C |
| S3 | 32.2 | Third CH2 of saturated chains ≥6 C |
| b | 27.3 | Branches ≥2 C (2 b carbons mean |
| carbon | | one for each side of the branch) |
| 2B4 | 23.4 | Second CH2 of butyl branches |

Molecular weight and molecular weight distribution of the samples were measured by the GPC instrument. FIG. 18 shows the molecular weight distribution curves obtained by the viscometer detector of the instrument. Differences in the molecular weight distribution (MWD) profiles were observed for the two LDPE samples (Sample 1 and 5). Sample 1 was synthesized at lower temperature and the polymer yield was very low. Sample 5 (LDPE) shows the highest average molecular weight and a broad molecular weight distribution. It shows a trimodal distribution, with a significant portion placed at very high molecular weight. Number average and weight average molecular weight as well as molecular weight distribution (MWD) of the samples are presented in Table 12. Increasing the amount of farnesene decreases the average molecular weight (Mn, Mw and Mz) and molecular weight distribution of the samples, FIG. 18. The farnesene comonomer acts as a chain transfer agent, decreasing significantly the average molecular weight and narrowing the MWD.

TABLE 12
Ethylene/farnesene copolymers characterization.

| Sample | 1 | 2 | 3 | 4 | 5 |
|---|---|---|---|---|---|
| Farnesene | 0 | 0.2 | 0.12 | 0.07 | 0 |
| (mol %) | | | | | |
| Tc (° C.) | 102.7/69.8 | 102.9/61.5 | 101.8/63 | 100.4/65.6 | 101/69.9 |
| □Hc (J/g) | 94/26 | 105/30 | 108/32 | 103/28 | 96/30 |
| Tm2 (° C.) | 112.9 | 112.3 | 112.2 | 112.3 | 111 |
| □Hm(J/g) | 116 | 129 | 129 | 124 | 121 |
| Mw (g/mol) | 298200 | 37900 | 87150 | 173950 | 964700 |
| Mn (g/mol) | 65700 | 11850 | 16400 | 24900 | 75800 |
| MWD | 4.59 | 3.19 | 5.32 | 7 | 12.76 |
| Mz (g/mol) | 1302100 | 434400 | 1169600 | 2198550 | 4146500 |

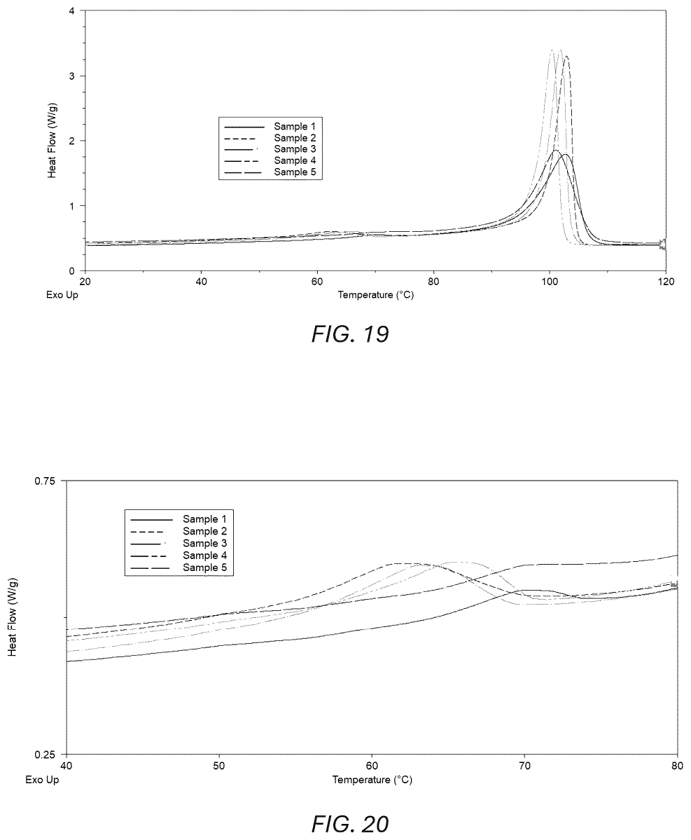

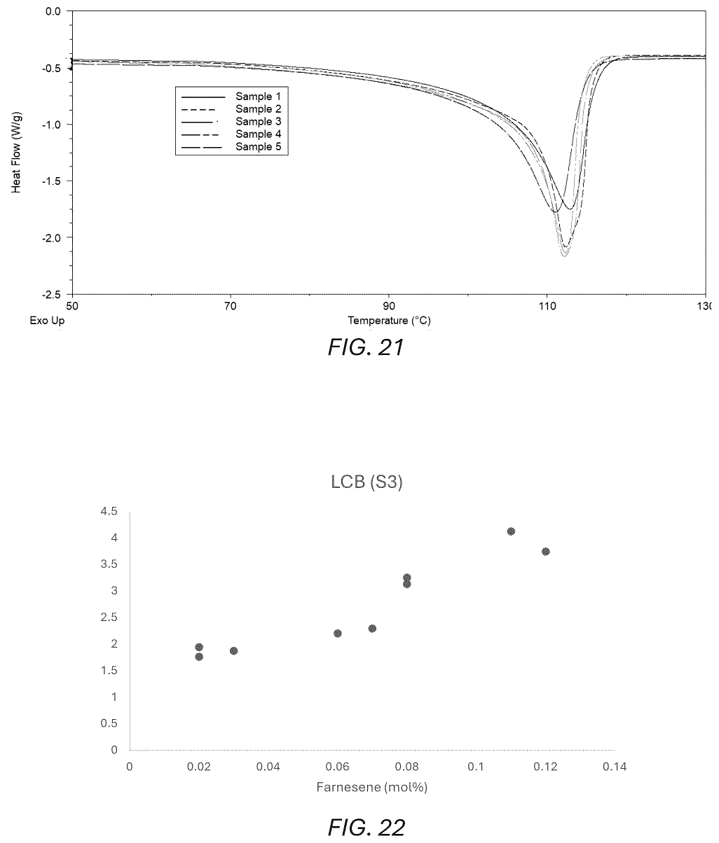

Melting and crystallization behavior of the samples were studied using DSC. Samples were cooled down from 160 to −20° C. and consequently heated up to 160° C. with a rate of 10° C./min. FIG. 19 shows the crystallization curves of the samples. The crystallization temperatures of the two the LDPEs (samples 1 and 5) are not much different than the crystallization temperatures of the three ethylene/farnesene copolymers (Table 12), but they start crystallizing at higher temperatures. Besides this, they show broader crystallization curves, pointing to a more heterogenous crystal thickness distribution. As the farnesene amount in the copolymers increases, the crystallization temperature increases. In comparison to LDPE, they show higher crystallization enthalpy and a more defined lower temperature crystallization peak, shifted to lower temperatures (FIG. 19, Table 12). As the amount of farnesene increases, decreases the temperature of the lower temperature crystallization peak (FIG. 20). Some differences in the enthalpy, crystallization and melting temperatures are observed between the two LDPE samples (sample 1 and 5) and are probably due to the different polymerization conditions, as mentioned before. All the samples show similar melting temperatures (Table 12). Sample 5 (LDPE) shows broader melting curve, indicating a more heterogeneous crystal size distribution (FIG. 21). A shoulder at higher temperature is observed in the ethylene/farnesene copolymers. As the amount of farnesene increases this shoulder becomes more evident and shifted to higher temperature (FIG. 21).

Hence, these data demonstrate that ethylene/farnesene copolymers with three different compositions can be produced under high-pressure conditions. A small increase in the farnesene content was enough to increase the LCB content of the copolymer, indicating that farnesene is a good comonomer to increase the melt strength of the copolymers.

### Example 4.1: Further Experiments with Ethylene and Farnesene in a Continuous High-Pressure Polymerization

Continuous high-pressure polymerizations of ethylene with farnesene was performed on an autoclave reactor in a mini plant used for polymer synthesis (2000 bar and T˜235° C.). There were tested 9 different compositions comprising ethylene and farnesene. The sample characterization are shown in Table 13.

TABLE 13
Ethylene/farnesene copolymers characterization

| Sample | 05 | 03 | 04 | 01 | 02 | 06 | 07 | 08 | 09 |
|---|---|---|---|---|---|---|---|---|---|
| Farnesene | 0.02 | 0.02 | 0.03 | 0.06 | 0.07 | 0.08 | 0.08 | 0.11 | 0.12 |
| (mol %) | | | | | | | | | |
| Farnesene | 0.11 | 0.16 | 0.18 | 0.41 | 0.52 | 0.55 | 0.57 | 0.76 | 0.84 |
| (wt %) | | | | | | | | | |
| Mw (g/mol) | 573250 | 312850 | 328250 | n.a. | 126600 | 111050 | 80500 | 78850 | 55200 |
| Mn (g/mol) | 32800 | 27050 | 25000 | n.a. | 19200 | 8700 | 8100 | 6400.0 | 5700 |
| Mw/Mn | 17.5 | 11.6 | 13.2 | n.a. | 6.6 | 12.8 | 10 | 12 | 10 |
| Mz (g/mol) | 3103350 | 2951150 | 3163300 | n.a. | 1496000 | 1718700 | 1450950 | 1578000.0 | 1197700 |
| Tm₂ (° C.) | 110 | 111.4 | 110.6 | 111 | 113.5 | 110.4 | 110.6 | 109.3/112 | 108.7/111.7 |
| DHm (J/g) | 127 | 127 | 127 | 134 | 129 | 122 | 131 | 119 | 122 |
| Tc (° C.) | 100.3/68.6 | 99.3/66.4 | 99.8/66.8 | 100/62.8 | 98.8/62.6 | 100.5/58.8 | 00.5/59. | 100/57.8 | 100.2/57.7 |

FIG. 22 shows the influence of farnesene amount in the LCB of the polymer. As the farnesene amount increases, the LCB also increases. It demonstrates a good advantage of the ethylene-based polymer to be applied in some applications such as extrusion coating films.

### Example 5: Polymerization of Ethylene and Farnesene in a Continuous High-Pressure Polymerization Using a Peroxide Compound as a Free-Radical Initiator

Continuous high-pressure polymerization of ethylene and farnesene was performed on a mini plant used for polymer synthesis at high pressures and temperatures.

Table 14 shows the polymerization conditions used to synthesize the ethylene/farnesene copolymers. Tert-Butyl peroxy-2-ethylhexanoate (TBPEH) was used as initiator and the copolymers were obtained with average pressures around 2000 bar and average temperatures around 225° C.

Four samples with target farnesene contents (feed: 0.2, 0.5, 1 and 2.5 wt %) were produced, and three transition samples (intermediate samples 1, 2 and 3) were also collected as indicated in Table 14. Before analysis, the samples were submitted to a purification and drying process to eliminate residual monomers.

TABLE 14
Ethylene/farnesene copolymers characterization

| | | Ethene | Farnesene | Farnese | TBPEH | Polymer | |
|---|---|---|---|---|---|---|---|
| | T_{polym} | feed | feed | feed | feed | mass | Conversion |
| Sample | (° C.) | (g/h) | (g/h) | (wt %) | (molppm) | (g) | (wt %) |
| 1 | 223 | 2000 | 4 | 0.2 | 8 | 4 | 1.3 |
| Intermediate 1 | ~223 | 2000 | — | 0.2-0.5 | 8 to 20 | 6.2 | — |
| 2 | 226 | 2000 | 10.1 | 0.5 | 20 | 7.8 | 2.3 |
| Intermediate 2 | ~226 | 2000 | — | 0.5-1 | 20 to 50 | 12.6 | — |
| 3 | 225 | 2000 | 20.2 | 1 | 50 | 16.6 | 5.0 |
| Intermediate 3 | ~225 | 2000 | — | 1-2.5 | 50 to 100 | 9.9 | — |
| 4 | 225 | 2000 | 51.3 | 2.5 | 100 | 6.5 | 1.9 |

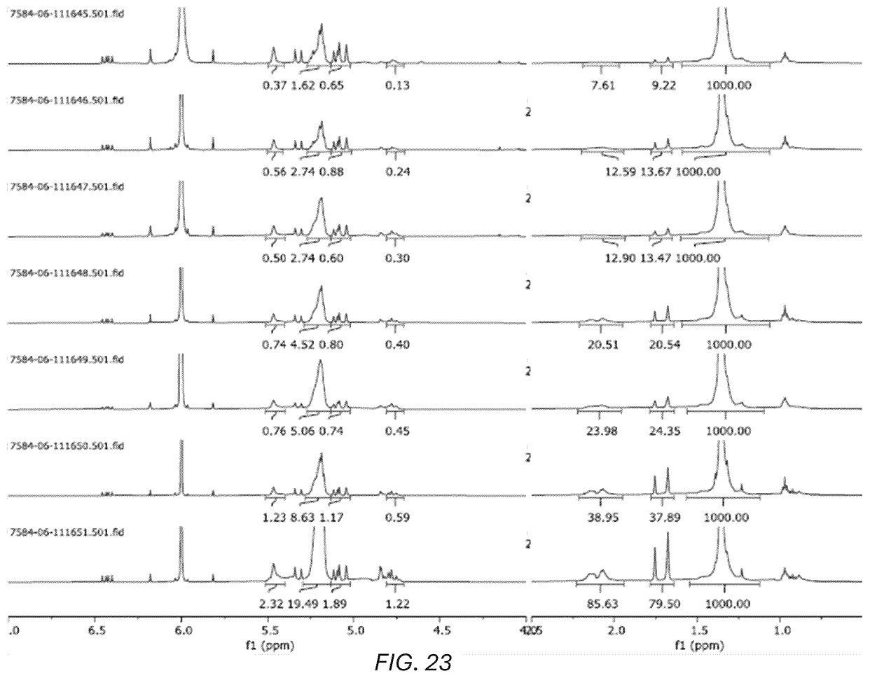

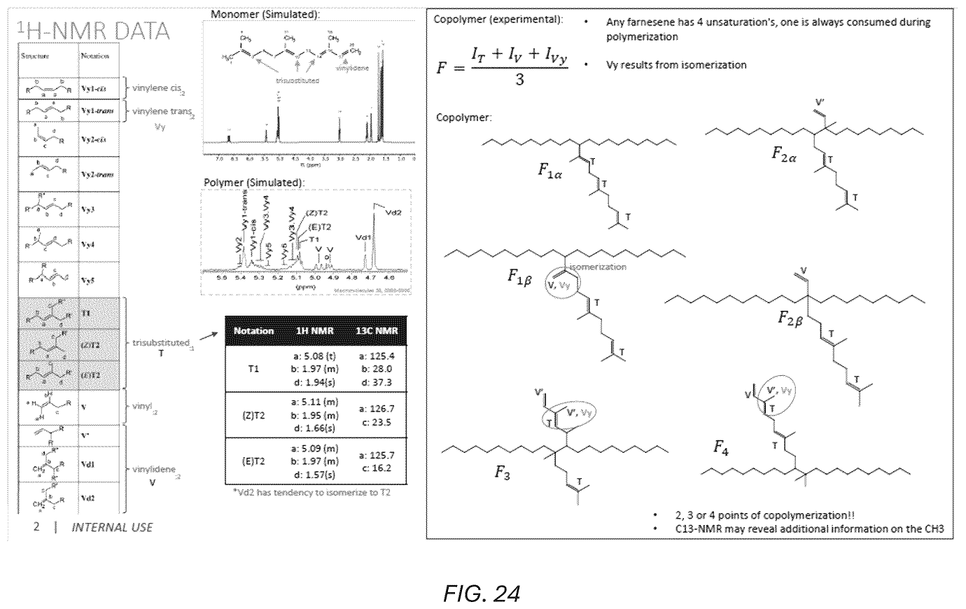

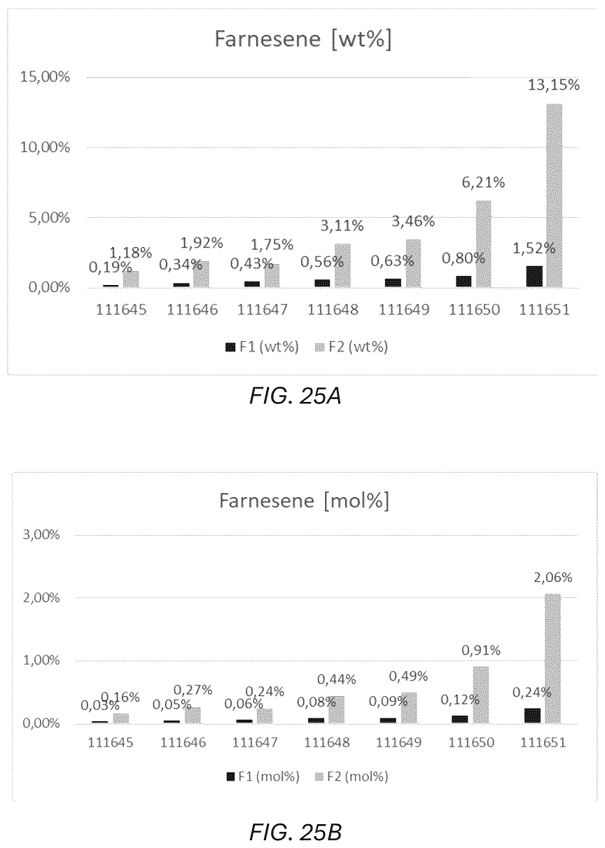

The ethylene/farnesene copolymers were analyzed by 13C and 1H NMR to determine the amount of unsaturation, long chain branching (LCB) and amount of farnesene incorporated in the copolymers. FIG. 23 shows the 1H NMR spectra of the ethylene/farnesene copolymers. Peak assignments were based on the work of Busico et al (“1H NMR Analysis of Chain Unsaturations in Ethene/1-Octene Copolymers Prepared with Metallocene Catalysts at High Temperature”, Macromolecules 2005, 38, 6988-6996) and on MNova simulation. FIG. 24 describes the peak assignments and the different possibilities that farnesene can add into the polymer backbone. The peak at around 4.9-5 ppm is attributed to the vinylidene group and the one at around 5.1 ppm is attributed to the three unsaturation of the farnesene molecule, as shown in FIG. 24. The unsaturation per 1000 C was calculated based on these two peaks. Considering 27 as the molar mass of the vinylidene group and 55 for the trisubstituted groups, the farnesene content in weight % was calculated and the results are shown in FIGS. 25A and 25B and Table 15.

TABLE 15
Farnesene content calculated using ¹H NMR

| | | Farnesene | Farnesene |
|---|---|---|---|
| | Farnesene | in the | in the |
| | in the feed | copolymer | copolymer |
| Sample | (wt %) | (wt %) | (mol %) |
| 1 | 0.2 | 1.37 | 0.19 |
| Intermediate | 0.2-0.5 | 2.26 | 0.32 |
| 1 | | | |
| 2 | 0.5 | 2.18 | 0.30 |
| Intermediate | 0.5-1 | 3.67 | 0.52 |
| 2 | | | |
| 3 | 1 | 4.09 | 0.58 |
| Intermediate | 1-2.5 | 7.01 | 1.02 |
| 3 | | | |
| 4 | 2.5 | 14.67 | 2.3 |

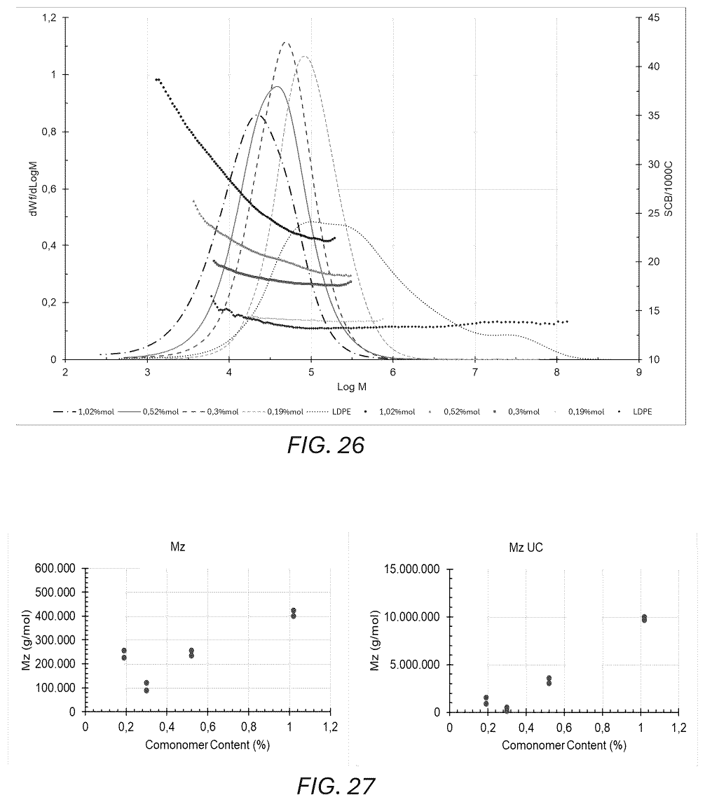

As the farnesene content increases, the molecular weight (Mn and M_{w}) decreases, confirming the previously observed chain transfer effect of farnesene. Low amounts of farnesene are sufficient to significantly decrease the molecular weight of the copolymers, as it can be seen in FIG. 26. The peak position reduces and the whole peak shifts to low molecular weight. Consequently, the average molecular weight reduces. The polydispersity of the peak is slightly increasing with comonomer. This can be observed by the enlargement of the width in the half height of the main peak in the GPC curve. Additionally, there is an extension in high molecular weight, of very low intensity for all farnesene copolymer samples, independently of farnesene content. The presence of this extension broadening the distribution, lead to a higher polydispersity as the amount of farnesene increases.

Comparing farnesene copolymers with the LDPE sample produced at same experimental conditions, it is possible to observe that the extension in the GPC curve of copolymer samples appears in the same molecular weight range as the high molecular weight tail of LDPE sample. The assumption, in this case, is that farnesene is hindering the formation of this high molecular weight species, so, reducing the intensity of this tail in such a way that only few chains are still present in this region. Based on this assumption, these chains that remains are those that don't suffer the influence of farnesene.

It was not possible to determine the amount of material that elutes in this extension, due to the low concentration of it. Mz average, that could be used as an estimation of the magnitude of this extension, does not look coherent among the samples with different comonomer content (FIG. 27). The reduction and almost disappearance of high molecular weight tail with the addition of farnesene seems to be the primary effect of this comonomer. The mass fraction and the level of extension of this tail in the copolymer samples does not show a direct correlation with the copolymer amount.

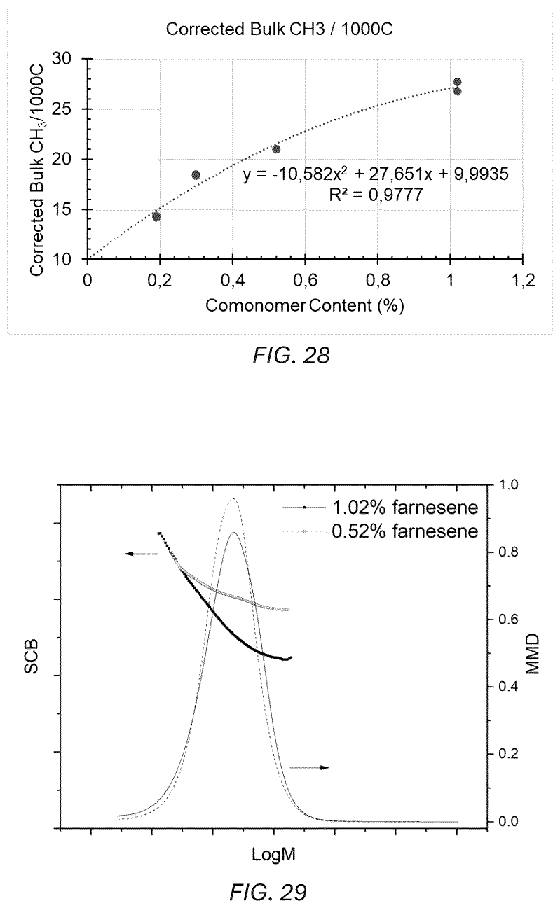

The farnesene content not only changes the molecular weight distribution (MWD), but also the short chain branching distribution (SCBD), as shown in FIGS. 26 and 28. In FIG. 26, it is possible to observe the SCBD. The LDPE presents a homogeneous distribution of SCB around 13-14 SCB/1000TC. Sample with 0.19 mol % of farnesene shows similar profile in a slightly higher value of SCB. At 0.32 mol % of farnesene and above, a different profile for SCBD is observed. Instead of a flat distribution, a descending plot as the molecular weight increase takes place, where the slope reduces as the farnesene content increases.

At 1.02 mol % of farnesene, a tendency of increase in the SCB/1000 C in a molecular weight higher than 100,000 g/mol is also observed. Its increase could be related to a new type of modification promoted by the comonomer, for example, a LCB generated by the connection of two different chains, bounded by the double bonds from farnesene.

The SCBD increases mainly in low molecular weight range. The behavior change is more evident at higher farnesene contents (above 0.5 mol %). If the MWD distribution of sample 0.52 and 1.02 mol % are shifted in such a way that the peaks are overlaid, the SCBD in the lower molecular weight range also overlays, as it can be seen in FIG. 29. It indicates that the formation of these more modified chain is not aleatory, but reproducible independently of the comonomer content, once the content is higher than a certain limit.

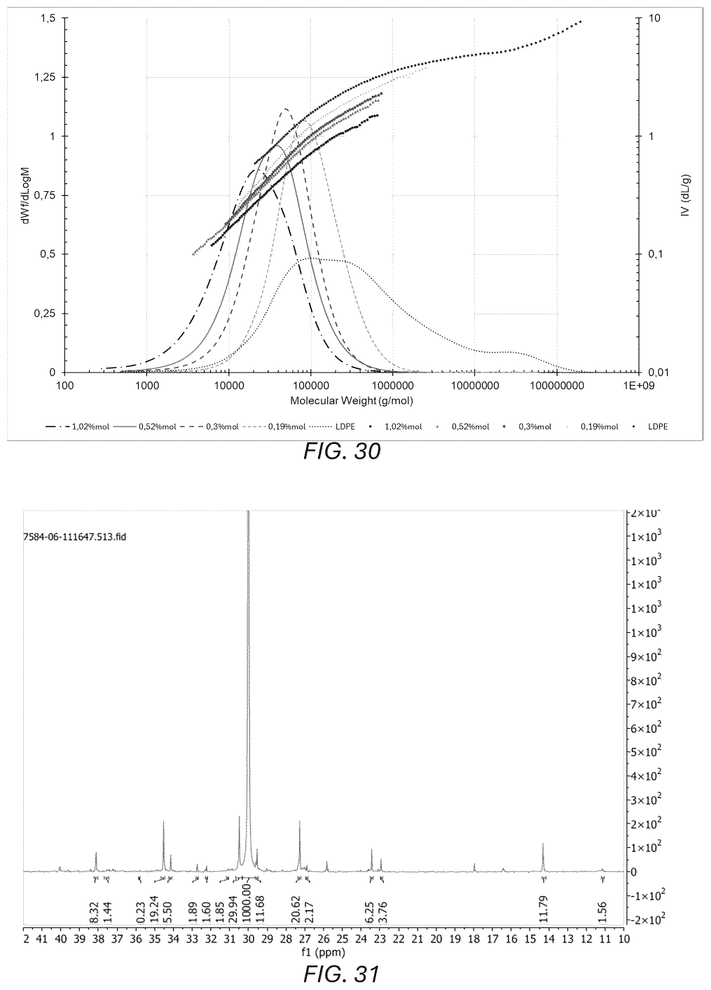

The MWD determined by viscometer detector as the intrinsic viscosity distribution is presented in FIG. 30. The MWD profile among the samples is similar to the ones obtained with infrared detector.

By a qualitative estimation, a higher deflection is observed for sample with 0.19 mol % farnesene. The deflection slope increases a little bit and keep constant for the samples with 0.3 and 0.52 mol % farnesene. In the sample with 1.02 mol % farnesene, a tendency of reduction on MH slope is observed. It seems that the presence of farnesene hinders the high molecular weight species formation as a whole. It seems to be the primary effect of its presence. As the addition of comonomer persists, other chemical modifications take place, mainly in low molecular weight, as indicated by the increase of the level of modification of these small chains. Above 1 mol % of farnesene, another effect seems to be present, a small increase in the level of modification in high molecular weight, that latter in this report, will be also correlated with molecular weight increase observed on CEF-MALS analysis.

The sample with 2.3 mol % farnesene was analyzed, but it presented a completely different profile of MWD, SCBD and MH plot. This would indicate that, at this comonomer amount, there are other side reactions and interactions that must be considered besides the ones discussed above.

TABLE 16
Average molecular weight and MWD measured by GPC-IR and GPC-DV.

| | | | | | |
|---|---|---|---|---|---|
| Farnesene | 0 | 0.19 | 0.3 | 0.52 | 1.02 |
| content (mol %) | | | | | |
| Farnesene | 0 | 1.37 | 2.18 | 3.67 | 7.01 |
| content (wt %) | | | | | |
| Mw | 816900 | 99772 | 45566 | 37832 | 23246 |
| Mn | 61800 | 44924 | 18877 | 13162 | 6203 |
| Mw/Mn | 13.2 | 2.2 | 2.4 | 2.9 | 3.8 |
| Mz | 5330600 | 241478 | 104306 | 245175 | 411944 |
| Mp | 225200 | 73152 | 38098 | 28505 | 14607 |
| Corrected Bulk | 14 | 14 | 18 | 21 | 27 |
| CH₃/1000 C. | | | | | |
| Mw UC | 3857200 | 145137 | 66355 | 62770 | 48183 |
| Mn UC | 58700 | 55881 | 24642 | 17891 | 8568 |
| Mw/Mn ( ) | 65.7 | 2.6 | 2.7 | 3.5 | 5.6 |
| Mz UC | 57250900 | 1231933 | 356976 | 3321610 | 9831120 |
| IV Bulk | 2.6 | 1.2 | 0.7 | 0.5 | 0.3 |

The branching content (short chain and long chain branches) were calculated through ¹³C NMR. In ¹³C NMR, long chain branching (LCB) is considered as any branch in the molecular structure with 6 or more carbon atoms (B₆₊). FIG. 31 shows a representative ¹³C NMR spectrum of an ethylene/farnesene copolymer. The peaks located at the chemical shifts of 38.2 and 32.2 ppm were used to calculate the amount of long chain branching (LCB (CH) and S3, respectively) and the results are shown in Table 17. S3 takes in account both B₆₊ and the chain ends of the main chain. S3 increases with the increase of farnesene content (Table 17). Considering that the molecular weight of the copolymers (Mn) decreases as the farnesene content increases, as shown in table 16, this increase in S3 is probably influenced by the chain ends of the main chain.

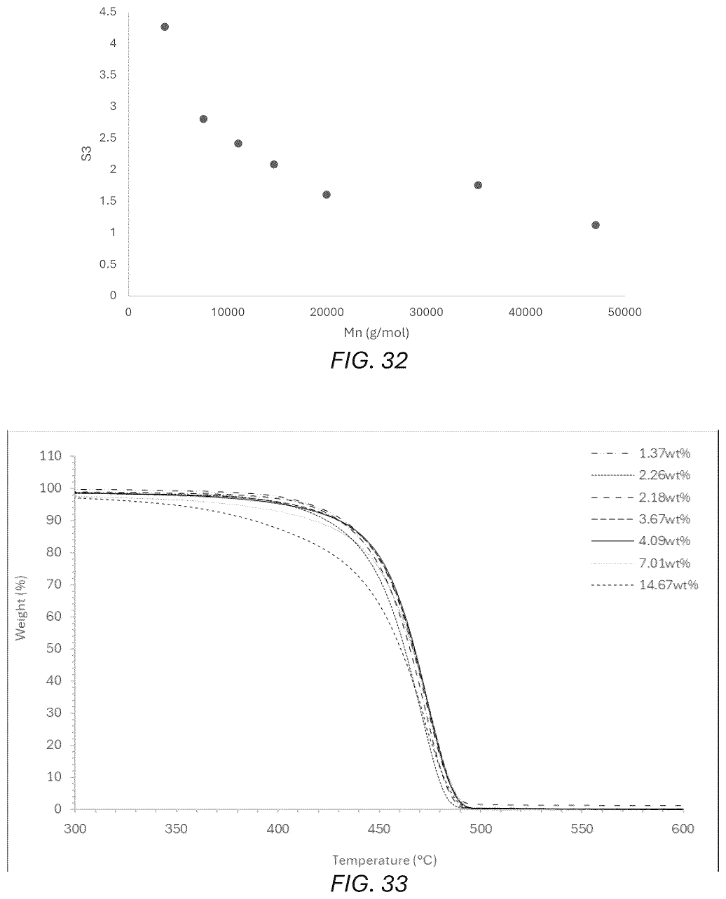

In other words, the lower the molecular weight, the higher the chain end amount. FIG. 32 shows the variation of S3 with Mn. In this sense, S3 cannot be used to determine the LCB content of these copolymers. Analyzing LCB obtained from the quantification of CH (first column of Table 17), the increase of LCB with the increase of farnesene content is only observed for sample 0.19 mol % and 0.30 mol %, where it is observed an increase of around 1 LCB per 1000 C. Not much variation on LCB amount was observed for the other samples, even with higher amounts of farnesene, such as 1 and 2.3 mol %.

TABLE 17
Branch content of ethylene/farnesene
copolymers determined by ¹³C NMR

| Sample | | LCB (CH) 38.2 ppm | S3 32.2 ppm | 2B4 23.4 ppm |
|---|---|---|---|---|
| 0.19 | mol % | 7.32 | 1.12 | 5.78 |
| 0.32 | mol % | 7.75 | 1.75 | 5.61 |
| 0.30 | mol % | 8.32 | 1.6 | 6.25 |
| 0.52 | mol % | 7.43 | 2.08 | 5.92 |
| 0.58 | mol % | 7.42 | 2.41 | 6.82 |
| 1.02 | mol % | 7.39 | 2.8 | 6.57 |
| 2.3 | mol % | 7.71 | 4.26 | 7.76 |

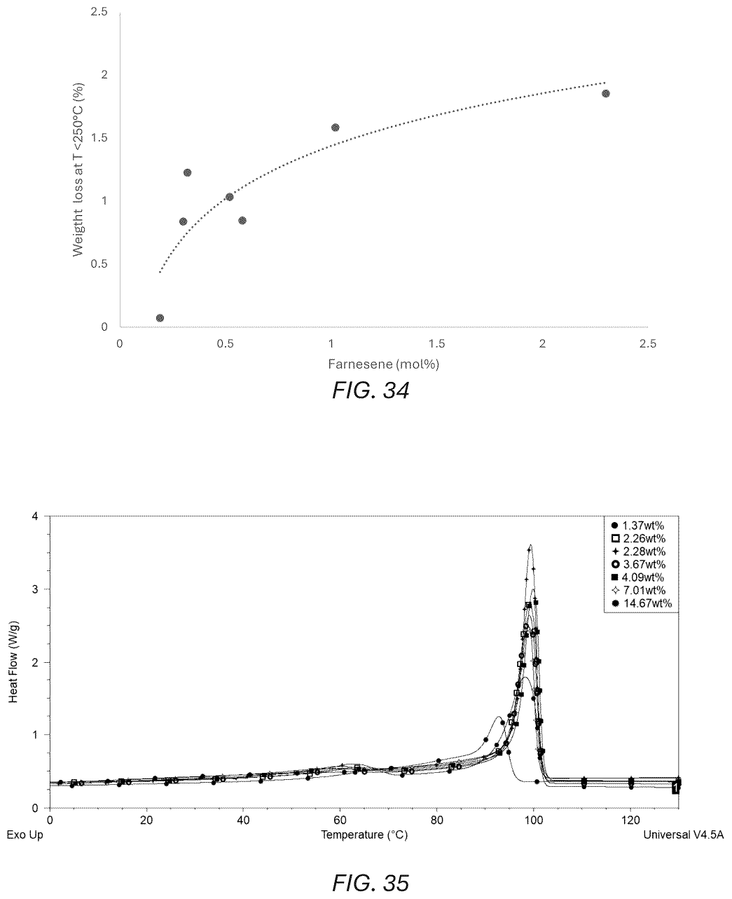

FIG. 33 shows the TGA thermograms of the ethylene/farnesene copolymers. The samples were heated at 20° C./min from room temperature to 600° C. under a nitrogen atmosphere. At temperatures lower than 250° C. all copolymers showed slight weight loss, probably related to the loss of volatiles. These volatiles are probably residual monomers that were not removed from the copolymers and/or oligomers (very low molecular weight copolymers). The weight loss at temperatures lower than 250° C. increases as the amount of farnesene increases, as can be seen in FIG. 34. The copolymers with low farnesene content (up to 3 wt %) showed weight loss at temperatures between 400° C. and 500° C. As the farnesene content increases the weight loss temperature decreases. The copolymer with the higher amount of farnesene (14.67 wt %) showed weight loss at temperatures between 250° C. and 500° C.

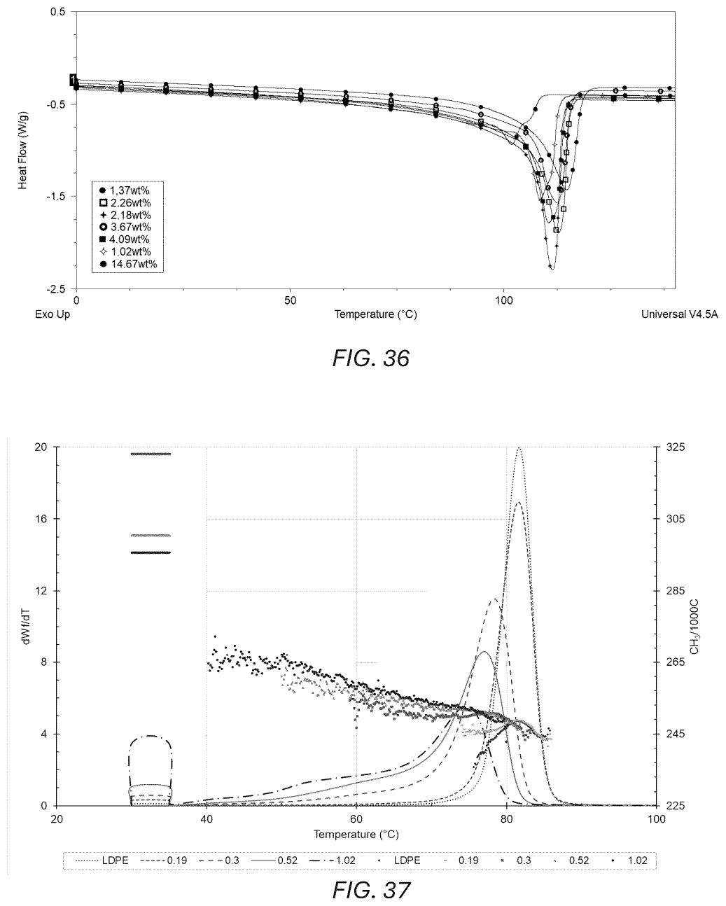

The melting and crystallization temperatures of the copolymers were determined by DSC. FIGS. 35 and 36 shows the crystallization and melting curves of the copolymers. In general, as the farnesene content increases, decreases the melting temperature (Table 18). The only exception is the sample with 3.67 wt % of farnesene that does not follow the trend. Since this is one of the transition samples, it is reasonable to consider that this sample may not be homogeneous as the specified ones (1, 2, 3 and 4). The higher the farnesene content the broad the endothermic curve, indicating a more heterogeneous crystal size distribution. The sample with 14.67 wt % of farnesene showed a trimodal melting distribution, indicating a heterogeneous distribution of farnesene in the backbone. The peak at the higher temperature is related to the chain segments with lower farnesene content, while the one at lower temperature is related to the chain segments with higher farnesene content. All samples showed two crystallization peaks, the main one (Tc₁) located at temperatures higher than 90° C. and a small one (Tc₂) located at temperatures between 49.7° C. and 66.3° C. In general, as the farnesene content increased, decreased the Tc₂, but no defined trend was observed for Tc₁. The sample with the highest farnesene content (14.67 wt %) showed the lowest Tc₁, but all the other samples showed similar Tc₁ (around 99° C.).

TABLE 18
Enthalpy, Melting and Crystallization Temperature
of ethylene/farnesene copolymers

| Sample | | Tm₂ (° C.) | ΔHm (J/g) | Tc (° C.) | ΔHc (J/g) |
|---|---|---|---|---|---|
| 1.37 | wt % | 114.6 | 113 | 66.3/98.4 | 122 |
| 2.26 | wt % | 112.8 | 121 | 63.4/99.2 | 128 |
| 2.18 | wt % | 111.4 | 131 | 62.2/99.4 | 137 |
| 3.67 | wt % | 112.4 | 109 | 60.5/99.1 | 130 |
| 4.09 | wt % | 110.5 | 127 | 59.2/99.9 | 131 |
| 7.01 | wt % | 108.5 | 107 | 55.9/99.0 | 117 |
| 14.67 | wt % | 101.8 | 85 | 49.7/92.8 | 94 |

Crystallization elution fractionation (CEF) equipped with multi-angle light scattering (MALS) was used to characterize the samples and understand the relationship between composition and molecular weight. In FIG. 37 is presented the CEF profile with the chemical composition distribution.

The CEF curve widens with the addition of farnesene. The increase in width is more pronounced in copolymer with 0.3 mol % or more of farnesene. There is no significant peak shift between the sample LDPE and 0.19 mol % of farnesene and the elution ends at the same temperature for both samples, indicating that, although a huge decrease in molecular weight is observed between these two samples, no difference in the elution of chains with higher crystallizable sequences were observed. The difference between LDPE and 0.19 wt % farnesene takes place in a temperature lower than 80° C. In this point, the curves start to differ one from each other, and the CEF profile widen at the same point that CH₃/1000 C increases, for sample with 0.19 mol % farnesene. A gradual change in CH₃/1000 C profile is observed as the comonomer content increases, where the sample 0.19 mol % is still more similar to LDPE profile than 0.3 mol % farnesene sample.

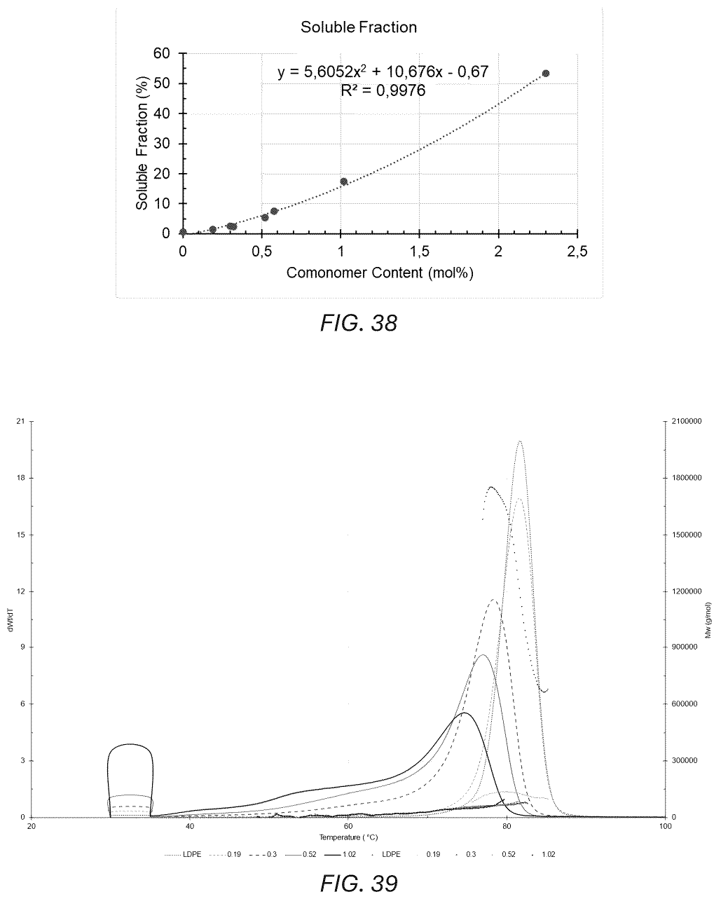

Bigger differences were seen when the farnesene content increases. Samples with 0.3 mol % of farnesene or more show a tail eluted in lower temperature that increases in concentration as the comonomer increases. These tails represent the more modified chains that are also low molecular weight chains. Soluble fraction amount and composition of soluble fraction is also affected by the presence of farnesene. Soluble fraction percentage increases with comonomer and this growth is stronger in samples with higher content of comonomer, as presented in FIG. 38.

The molecular weight distribution along CEF profile can help to understand the modification promoted by farnesene. The CEF-MALS profile is presented in FIG. 39.

The MWD change drastically with the presence of farnesene, as could be verified also by GPC. Nevertheless, it is interesting to observe that for LDPE sample, the region with higher value of molecular weight is at intermediate temperatures. It is well known by GPC analyses that the LCBs are concentrated in the high molecular weight region and that LCB hinders the crystallization process, mainly in the kinetics step due the low mobility of these chains. Then, it is feasible to assume that this high molecular weight chains are indeed branched. This would also explain the decrease in CH₃/1000 C, once the chain are long chains with long branches. In this sense, it is reasonable to infer that the major difference in composition and in the profile of MWD by CEF is occurring in the region with higher concentration of LCB (according to LDPE profile).

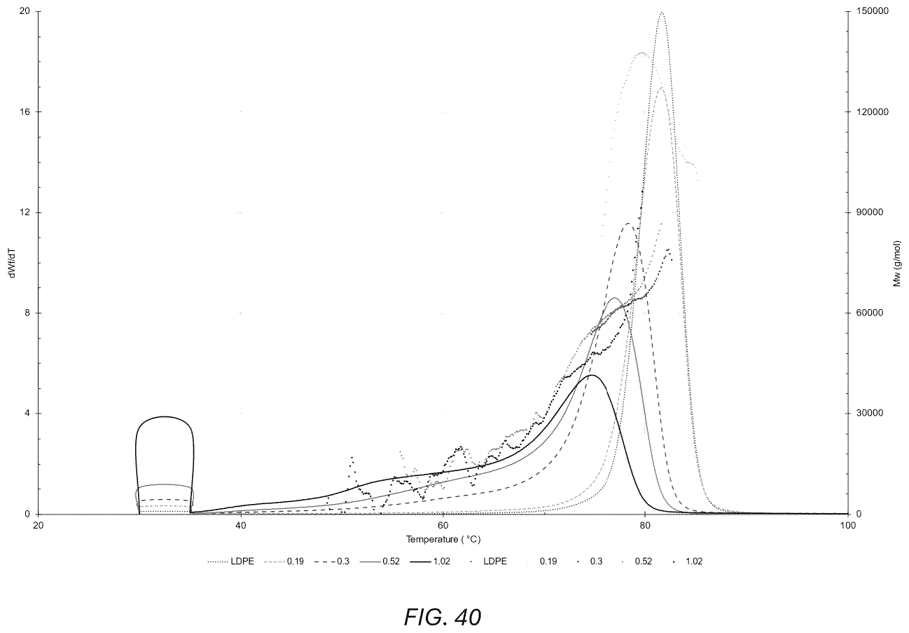

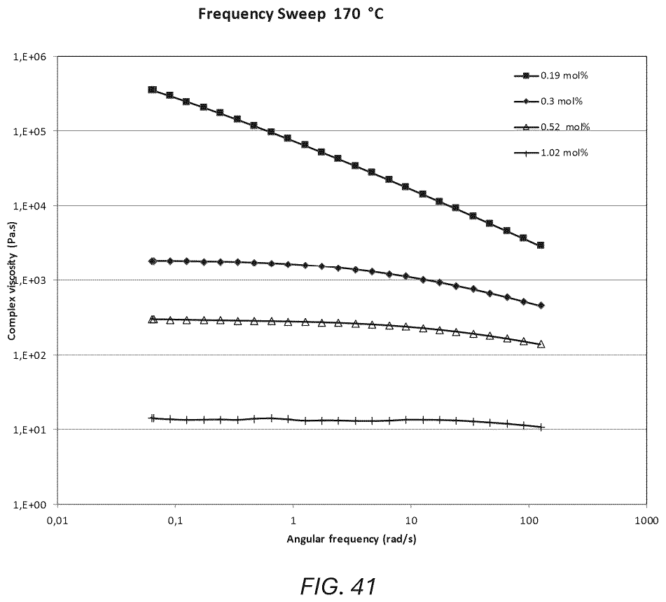

Sample with 0.19 mol % of farnesene shows a profile similar to LDPE, although, for this sample the maximum value of molecular weight happened at 80° C., a temperature slightly superior that the one presented for LDPE. The same profile, overlaying only the copolymer samples, is presented in FIG. 40, to better observe the difference among the samples with different comonomer content.

For the copolymers, it is also possible to observe a gradual change in MWD profile by CEF. The reduction in molecular weight is following the increase in comonomer content. The MWD profiles for 0.3 and 0.52 mol % farnesene is almost overlaid, with exception of the components eluted at higher temperature. Even for the sample with 1.02 mol % that present the lower molecular weight value in the peak, there is an upswing in temperatures near 80° C. leading to a molecular weight higher than the one obtained for the sample 0.3 mol %. The increment in molecular weight observed in both techniques (in a specific region of CEF and GPC curves) may have two possible main reasons: it is part of LDPE chains that were not affected by farnesene or they are different chains connected by a farnesene group.

FIG. 41 shows the complex viscosity of four ethylene/farnesene copolymers at different shear rates. Among the four samples, the one with the lowest amount of farnesene (0.19 mol %) shows the higher complex viscosity. This is expected since this sample also shows the highest molecular weight. As the farnesene content decreases, decreases the complex viscosity. Zero shear viscosity is obtained by extrapolating the viscosity values to a zero shear rate. Zero shear viscosity is influenced by the molecular weight, MWD, amount and type of branches.

From the examples above, it is clear that the presence of a terpene comonomer in an ethylene polymer in different amounts can control the occurrence of LCB/SCB and their distribution, thereby being possible to have a different design of polymers. Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. An ethylene-based polymer comprising from 0.01 to 25 wt. % of at least one terpene comonomer comprising 1 to 5 isoprene units, based on a total weight of the ethylene-based polymer.

2. The ethylene-based polymer according to claim 1, wherein the at least one terpene comonomer is selected from the group comprising isoprene, prenol, limonene, myrcene, ocimene, geraniol, pinene, Δ3-carene, canfene, sabinene, terpinene, citral, citronellol, geraniol, lavandulol, linalool, terpineol, thymol, menthol, carvone, eucalyptol, perillaldehyde, thujone, thujene, borneol, camphor, camphene, carvacrol, pulegone, ascaridole, farnesene, farnesol, zingiberene, santalene, AR-curcumene, sesquifelandrene, bisabolene, caryophyllene, gurjunene, selinene, humulene, valencene, AR-diidroturmerona, AR-turmerol, bisabolol, cadinol, nerolidol, nerol, orto acetoxi bisabolol, sesquicineo, santalol, thujopsene, umbellulone, khushimol, phytol, 9-geranyl-α-terpineol, sclareol, marrubiin, casbene, cafestol, kahweol, cembrene, taxadiene, taxol, geranylfarnesol or combinations thereof.

3. The ethylene-based polymer according to claim 1, wherein the at least one terpene comonomer comprises 1 to 3 isoprene units.

4. The ethylene-based polymer according to claim 3, wherein the at least one terpene comonomer is selected from isoprene, myrcene, Δ3-carene, ocimene, limonene, terpinene, sabinene, pulegone, farnesene, farnesol and combinations thereof.

5. The ethylene-based polymer according to claim 3, wherein the at least one terpene comonomer is selected from isoprene, α-myrcene, β-myrcene, α-ocimene, β-ocimene, α-farnesene, β-farnesene, or combinations thereof.

6. The ethylene-based polymer according to claim 1, wherein the at least one terpene comonomer is present in the ethylene-based polymer in an amount from 0.01 to 15 wt. %, based on the total weight of the ethylene-based polymer.

7. The ethylene-based polymer according to claim 1, comprising a further comonomer selected from C₃-C₈ α-olefins, branched vinyl ester monomers and vinyl acetate.

8. The ethylene-based polymer according to claim 7, wherein the ethylene-based polymer further comprises a branched vinyl ester monomer having the general chemical formula (I): 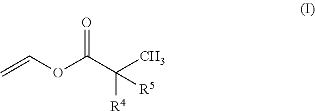
wherein R⁴ and R⁵ have a combined carbon number of 6 or 7.

9. The ethylene-based polymer according to claim 7, wherein the further comonomer is present in an amount of up to 50 wt. %, based on the total weight of the ethylene-based polymer.

10. The ethylene-based polymer according to claim 1, wherein the polymer has a melt flow index ranging from 0.1 to 100 g/10 min (2.16 kg/190° C.), measured according to ASTM D1238.

11. The ethylene-based polymer according to claim 1, wherein the polymer is a low-density polyethylene (LDPE) produced in a high-pressure reactor selected from autoclave reactor and tubular reactor.

12. The ethylene-based polymer according to claim 1, wherein the polymer presents one or more of the following properties:
a density varying from 0.910 to 0.925 g/cm³, measured according to ASTM D792 Method B;
Mw/Mn varying from 1 to 60;
a long chain branching frequency LCBf, calculated by GPC analysis ranging from 0 to 10;
a long chain branching content, measured by 13CNMR, ranging from 0 to 10;
a melting temperature (Tm) measured according to ASTM D3418 by DSC ranging from 20° C. to 200° C.; and
a crystallization temperature (Tc) measured according to ASTM D3418 by DSC ranging from 20° C. to 200° C.

13. A method to produce an ethylene-based polymer under a high-pressure system comprising:
feeding an ethylene stream to a polymerization reactor,
feeding at least one terpene comonomer comprising 1 to 5 isoprene units to the polymerization reactor,
performing a polymerization reaction in the presence of at least one free radical initiator at a pressure from 1100 to 3500 bar to produce an ethylene-based polymer, and
recovering the ethylene-based polymer from the polymerization reactor.

14. The method according to claim 13, wherein the polymerization reactor is selected from tubular and autoclave, the polymerization occurs at a pressure varying from 1500 to 3500 bar, the polymerization occurs at a temperature ranging from 150 to 350° C., and/or polymerization step is single step or multiple steps.

15. The method according to claim 13, wherein the at least one terpene comonomer is added to the ethylene stream in an amount ranging from 0.01 to 25 wt. %, based on a total weight of the ethylene-based polymer.

16. The method according to claim 13, wherein the at least one free radical initiator is selected from oxygen, peroxide compounds, azo-compounds and Carbon-Carbon (“C—C”) free radical initiators.

17. The method according to claim 16, wherein the at least one free radical initiator includes peroxide compounds selected from benzoyl peroxide; dicumyl peroxide; di-tert-butyl peroxide; tert-butyl cumyl peroxide; t-butyl-peroxy-2-ethyl-hexanoate; tert-butyl peroxypivalate; tertiary butyl peroxyneodecanoate; t-butyl-peroxy-benzoate; t-butyl-peroxy-2-ethyl-hexanoate; tert-butyl 3,5,5-trimethylhexanoate peroxide; tert-butyl peroxybenzoate; 2-ethylhexyl carbonate tert-butyl peroxide; 2,5-dimethyl-2,5-di(tert-butylperoxide) hexane; 1,1-di(tert-butylperoxide)-3,3,5-trimethylcyclohexane; 2,5-dimethyl-2,5-di(tert-butylperoxide) hexyne-3; 3,3,5,7,7-pentamethyl-1,2,4-trioxepane; butyl 4,4-di(tert-butylperoxide) valerate; di(2,4-dichlorobenzoyl) peroxide; di(4-methylbenzoyl) peroxide; peroxide di(tert-butylperoxyisopropyl)benzene, 2,5-di(cumylperoxy)-2,5-dimethyl hexane, 2,5-di(cumylperoxy)-2,5-dimethyl hexyne-3,4-methyl-4-(t-butylperoxy)-2-pentanol, 4-methyl-4-(t-amylperoxy)-2-pentano 1,4-methyl-4-(cumylperoxy)-2-pentanol, 4-methyl-4-(t-butylperoxy)-2-pentanone, 4-methyl-4-(t-amylperoxy)-2-pentanone, 4-methyl-4-(cumylperoxy)-2-pentanone, 2,5-dimethyl-2,5-di(t-butylperoxy) hexane, 2,5-dimethyl-2,5-di(t-amylperoxy) hexane, 2,5-dimethyl-2,5-di(t-butylperoxy) hexyne-3, 2,5-dimethyl-2,5-di(t-amylperoxy) hexyne-3, 2,5-dimethyl-2-t-butylperoxy-5-hydroperoxyhexane, 2,5-dimethyl-2-cumylperoxy-5-hydroperoxy hexane, 2,5-dimethyl-2-t-amylperoxy-5-hydroperoxyhexane, m/p-alpha, alpha-di[(t-butylperoxy)isopropyl]benzene, 1,3,5-tris(t-butylperoxyisopropyl)benzene, 1,3,5-tris(t-amylperoxyisopropyl)benzene, 1,3,5-tris(cumylperoxyisopropyl)benzene, di[1,3-dimethyl-3-(t-butylperoxy)butyl]carbonate, di[1,3-dimethyl-3-(t-amylperoxy)butyl]carbonate, di[1,3-dimethyl-3-(cumylperoxy)butyl]carbonate, di-t-amyl peroxide, t-amyl cumyl peroxide, t-butyl-isopropenylcumyl peroxide, 2,4,6-tri(butylperoxy)-s-triazine, 1,3,5-tri[1-(t-butylperoxy)-1-methylethyl]benzene, 1,3,5-tri-[(t-butylperoxy)-isopropyl]benzene, 1,3-dimethyl-3-(t-butylperoxy) butanol, 1,3-dimethyl-3-(t-amylperoxy) butanol, di(2-phenoxyethyl) peroxydicarbonate, di(4-t-butylcyclohexyl) peroxydicarbonate, dimyristyl peroxydicarbonate, dibenzyl peroxydicarbonate, di(isobornyl) peroxydicarbonate, 3-cumylperoxy-1,3-dimethylbutyl methacrylate, 3-t-butylperoxy-1,3-dimethylbutyl methacrylate, 3-t-amylperoxy-1,3-dimethylbutylmethacrylate, tri(1,3-dimethyl-3-t-butylperoxy butyloxy) vinyl silane, 1,3-dimethyl-3-(t-butylperoxy)butyl N-[1-{3-(1-methylethenyl)-phenyl}-1-methylethyl]carbamate, 1,3-dimethyl-3-(t-amylperoxy)butyl N-[1-{3 (1-methylethenyl)-phenyl}-1-methylethyl]carbamate, 1,3-dimethyl-3-(cumylperoxy))butyl N-[1-{3-(1-methylethenyl)-phenyl}-1-methylethyl]carbamate, 1,1-di(t-butylperoxy)-3,3,5-trimethylcyclohexane, 1,1-di(t-butylperoxy)cyclohexane, n-butyl 4,4-di(t-amylperoxy) valerate, ethyl 3,3-di(t-butylperoxy) butyrate, 2,2-di(t-amylperoxy) propane, 3,6,6,9,9-pentamethyl-3-ethoxycabonylmethyl-1,2,4,5-tetraoxacyclononane, n-buty 1-4,4OO-t-amyl-O-hydrogen-monoperoxy-succinate, 3,6,9, triethyl-3,6,9-trimethyl-1,4,7-triperoxynonane (or methyl ethyl ketone peroxide cyclic trimer), methyl ethyl ketone peroxide cyclic dimer, 3,3,6,6,9,9-hexamethyl-1,2,4,5-tetraoxacyclononane, 2,5-dimethyl-2,5-di(benzoylperoxy) hexane, t-butyl perbenzoate, t-butylperoxy acetate, t-butylperoxy-2-ethyl hexanoate, t-amyl perbenzoate, t-amyl peroxy acetate, t-butyl peroxy isobutyrate, 3-hydroxy-1,1-dimethyl t-butyl peroxy-2-ethyl hexanoate, OO-t-amyl-O-hydrogen-monoperoxy succinate, OO-t-butyl-O-hydrogen-monoperoxy succinate, di-t-butyl diperoxyphthalate, t-butylperoxy (3,3,5-trimethylhexanoate), 1,4-bis(t-butylperoxycarbo)cyclohexane, t-butylperoxy-3,5,5-trimethylhexanoate, t-butyl-peroxy-(cis-3-carboxy) propionate, allyl 3-methyl-3-t-butylperoxy butyrate, OO-t-butyl-O-isopropylmonoperoxy carbonate, OO-t-butyl-O-(2-ethyl hexyl) monoperoxy carbonate, 1,1,1-tris[2-(t-butylperoxy-carbonyloxy) ethoxymethyl]propane, 1,1,1-tris[2-(t-amylperoxy-carbonyloxy) ethoxymethyl]propane, 1,1,1-tris[2-(cumylperoxy-cabonyloxy) ethoxymethyl]propane, OO-t-amyl-O-isopropylmonoperoxy carbonate, di(4-methylbenzoyl) peroxide, di(3-methylbenzoyl) peroxide, di(2-methylbenzoyl) peroxide, didecanoyl peroxide, dilauroyl peroxide, 2,4-dibromo-benzoyl peroxide, succinic acid peroxide, dibenzoyl peroxide, di(2,4-dichloro-benzoyl) peroxide, and combinations thereof.

18. The method according to claim 16, wherein the at least one free radical initiator includes azo-compounds selected from azobisisobutyronitrile (AIBN), 2,2′-azobis(amidinopropyl) dihydrochloride, or selected from azo-peroxide initiators that contain mixtures of peroxide with azodinitrile compounds such as 2,2′-azobis(2-methyl-pentanenitrile), 2,2′-azobis(2methyl-butanenitrile), 2,2′-azobis(2-ethyl-pentanenitrile), 2-[(1-cyano-1-methylpropyl) azo]-2-methyl-pentanenitrile, 2-[(1-cyano-1-ethylpropyl) azo]-2-methyl-butanenitrile, 2-[(1-cyano-1-methylpropyl) azo]-2-ethyl, and combinations thereof.

19. The method according to claim 16, wherein the at least one free radical initiator includes Carbon-Carbon (“C—C”) free radical initiators selected from 2,3-dimethyl-2,3-diphenylbutane, 3,4-dimethyl-3,4-diphenylhexane, 3,4-diethyl-3,4-diphenylhexane, 3,4-dibenzyl-3,4ditolylhexane, 2,7-dimethyl-4,5-diethyl-4,5-diphenyloctane, 3,4-dibenzyl-3,4-diphenylhexane, and combinations thereof.

20. The method according to claim 16, wherein the at least one free radical initiator is added to the polymerization mixture in an amount ranging from 0.0001 wt % to 5 wt %, based on a weight of the total polymerization mixture.

21. An extrusion coating film comprising the ethylene-based polymer of claim 1.

22. An article comprising the extrusion coating film of claim 21, wherein the article is selected from packaging, adhesives and footwears.
